(19) United States
(12) Patent Application Publication
(10) Pub. No.: US 2026/0113528 A1
(43) Pub. Date: Apr. 23, 2026

(54) ENDOSCOPE SYSTEM, BENDING CONTROL METHOD, AND RECORDING MEDIUM

(71) Applicant: Evident Inspection Technologies Japan Corporation, Tatsuno-machi (JP)

(72) Inventor: Yukiyoshi YAGI, Kamiina-gun (JP)

(73) Assignee: Evident Inspection Technologies Japan Corporation, Tatsuno-machi (JP)

(21) Appl. No.: 19/358,631

(22) Filed: Oct. 15, 2025

(30) Foreign Application Priority Data
Oct. 22, 2024 (JP) 2024-186098

(51) Int. Cl. H04N 23/50; H04N 23/63

(52) U.S. Cl. CPC H04N 23/555; H04N 23/633

(57) ABSTRACT

An endoscope system includes an insertion unit and a processor. The processor receives, from a device, position information indicating a position in a bending operation region including two or more direction designation regions corresponding to two or more bending directions of the insertion unit. Each of the two or more direction designation regions includes a first region and a second region that are different from each other. The processor bends the insertion unit in a first bending mode in a bending direction corresponding to a direction designation region including the first region in which the position is included. Alternatively, the processor bends the insertion unit in a second bending mode different from the first bending mode in a bending direction corresponding to a direction designation region including the second region in which the position is included.

### BACKGROUND OF THE INVENTION

### Field of the Invention

The present invention relates to an endoscope system, a bending control method, and a recording medium.

Priority is claimed on Japanese Patent Application No. 2024-186098, filed October 22, 2024, the content of which is incorporated herein by reference.

### Description of Related Art

An industrial endoscope device has been used for inspection of abnormality, corrosion, and the like in boilers, pipes, aircraft engines, and the like. The endoscope device includes an insertion unit for acquiring an image. A user inserts the insertion unit into a subject and acquires an image of an inspection region in the subject. The user observes the image and inspects the inspection region. The insertion unit includes a bending portion for bending the insertion unit. The user can bend the insertion unit by performing a bending operation.

In the endoscope device, two or more bending modes associated with bending control are prepared. The endoscope device switches between the two or more bending modes in accordance with necessary functions.

In the technique disclosed in Published Japanese Translation No. 2018-523869 of the PCT International Publication, a direction of a borescope is controlled in accordance with a specific operation performed on a screen. Specifically, in the technique, a connection part of a borescope is bent in accordance with the distance between the center of the screen and a tapped position. In Published Japanese Translation No. 2018-523869 of the PCT International Publication, it is disclosed that specific operations can be used to control an operation mode.

### SUMMARY OF THE INVENTION

According to an aspect of the present invention, an endoscope system includes both an insertion unit configured to be bendable and to acquire an optical image in an observation target and a processor. The processor receives, from a device, position information indicating a position in a bending operation region including two or more direction designation regions corresponding to two or more bending directions of the insertion unit. Each of the two or more direction designation regions includes a first region and a second region that are different from each other. The processor bends the insertion unit in a first bending mode in a bending direction corresponding to a direction designation region including the first region when the position indicated by the position information is included in the first region. The processor bends the insertion unit in a second bending mode different from the first bending mode in a bending direction corresponding to a direction designation region including the second region when the position indicated by the position information is included in the second region.

According to an aspect of the present invention, each of the two or more direction designation regions may include a third region that is different from both the first region and the second region. The processor need not bend the insertion unit when the position indicated by the position information is included in the third region.

According to an aspect of the present invention, each of the two or more direction designation regions may include a third region that is different from both the first region and the second region. The processor may bend the insertion unit in the first bending mode or the second bending mode in accordance with the position indicated by the position information that has been previously received when the position indicated by the position information is included in the third region.

According to an aspect of the present invention, the third region may be located between the first region and the second region. The processor may bend the insertion unit in the first bending mode when the position indicated by the position information that has been previously received is included in the first region. The processor may bend the insertion unit in the second bending mode when the position indicated by the position information that has been previously received is included in the second region.

According to an aspect of the present invention, each of the first region and the second region may include two or more sub-regions. The processor may bend the insertion unit based on a control value in a sub-region corresponding to the position indicated by the position information out of the two or more sub-regions.

According to an aspect of the present invention, the processor may acquire, from a storage medium, the control value associated with the sub-region corresponding to the position indicated by the position information.

According to an aspect of the present invention, the processor may acquire the control value based on the distance between the position indicated by the position information and a reference position preset in the bending operation region.

According to an aspect of the present invention, the processor may start receiving the position information at a first timing, end receiving the position information at a second timing different from the first timing, and continuously receive the position information between the first timing and the second timing.

According to an aspect of the present invention, the processor may display the first region and the second region on a display.

According to an aspect of the present invention, the processor may set the bending operation region such that the first region and the second region are disposed to be point-symmetric with respect to a reference position.

According to an aspect of the present invention, the processor may set the bending operation region to occupy greater than or equal to a half of a screen of a display.

According to an aspect of the present invention, the processor may receive, from the device, second position information indicating a position on a screen of a display and set the bending operation region on the display based on the second position information.

According to an aspect of the present invention, the endoscope system may include an endoscope device including the insertion unit, the device, and the processor.

According to an aspect of the present invention, the endoscope system may include an endoscope device including the insertion unit and an operation device separated from the endoscope device and configured to communicate with the endoscope device. The operation device may include the device and the processor.

According to an aspect of the present invention, the device may be a touch panel. The processor may receive the position information indicating a position at which an object has touched the touch panel.

According to an aspect of the present invention, the device may be a mouse. The processor may receive the position information indicating the position of the bending operation region corresponding to a position of the mouse.

According to an aspect of the present invention, there is provided a bending control method of controlling a bending operation of an insertion unit configured to be bendable and to acquire an optical image in an observation target. The bending control method includes receiving, from a device, position information indicating a position in a bending operation region including two or more direction designation regions corresponding to two or more bending directions of the insertion unit. Each of the two or more direction designation regions includes a first region and a second region that are different from each other. The bending control method further includes: bending the insertion unit in a first bending mode in a bending direction corresponding to a direction designation region including the first region when the position indicated by the position information is included in the first region; and bending the insertion unit in a second bending mode different from the first bending mode in a bending direction corresponding to a direction designation region including the second region when the position indicated by the position information is included in the second region.

According to an aspect of the present invention, a non-transitory computer-readable recording medium stores a program causing a computer to execute a process of controlling a bending operation of an insertion unit configured to be bendable and to acquire an optical image in an observation target. The computer receives, from a device, position information indicating a position in a bending operation region including two or more direction designation regions corresponding to two or more bending directions of the insertion unit. Each of the two or more direction designation regions includes a first region and a second region that are different from each other. The computer bends the insertion unit in a first bending mode in a bending direction corresponding to a direction designation region including the first region when the position indicated by the position information is included in the first region. The computer bends the insertion unit in a second bending mode different from the first bending mode in a bending direction corresponding to a direction designation region including the second region when the position indicated by the position information is included in the second region.

### BRIEF DESCRIPTION OF THE DRAWINGS

FIG. 1 is a block diagram showing an example of the configuration of an endoscope system according to a first embodiment of the present invention.

FIG. 2 is a diagram showing an example of a bending operation region in the first embodiment of the present invention.

FIG. 3 is a diagram showing an example of the bending operation region in the first embodiment of the present invention.

FIG. 4 is a diagram showing an example of a change in position of a touch region in the first embodiment of the present invention.

FIG. 5 is a diagram showing an example of a bending mode in the first embodiment of the present invention.

FIG. 6 is a flowchart showing an example of a procedure of a process for determining a bending mode and a bending control value in the first embodiment of the present invention.

FIG. 7 is a diagram showing an example of the bending operation region in the first embodiment of the present invention.

FIG. 8 is a diagram showing an example of the bending operation region in the first embodiment of the present invention.

FIG. 9 is a flowchart showing an example of a procedure of a process for determining a bending mode and a bending control value in the first embodiment of the present invention.

FIG. 10 is a block diagram showing an example of the configuration of an endoscope system according to a first modified example of the first embodiment of the present invention.

FIG. 11 is a block diagram showing an example of the configuration of an endoscope system according to a second modified example of the first embodiment of the present invention.

FIG. 12 is a diagram showing an example of a bending operation region in a second embodiment of the present invention.

FIG. 13 is a diagram showing an example of a bending control value in the second embodiment of the present invention.

FIG. 14 is a flowchart showing an example of a procedure of a process for determining a bending mode and a bending control value in the second embodiment of the present invention.

FIG. 15 is a diagram showing an example of a bending operation region in a first modified example of the second embodiment of the present invention.

FIG. 16 is a diagram showing an example of the bending operation region in the first modified example of the second embodiment of the present invention.

FIG. 17 is a flowchart showing an example of a procedure of a process for determining a bending mode and a bending control value in a second modified example of the second embodiment of the present invention.

FIG. 18 is a diagram showing an example of a bending operation region in a third embodiment of the present invention.

FIG. 19 is a diagram showing an example of a change in position of a touch region in the third embodiment of the present invention.

FIG. 20 is a diagram showing an example of a bending mode in the third embodiment of the present invention.

FIG. 21 is a flowchart showing an example of a procedure of a process for determining a bending mode and a bending control value in the third embodiment of the present invention.

FIG. 22 is a diagram showing an example of a bending operation region in a first modified example of the third embodiment of the present invention.

FIG. 23 is a diagram showing an example of a bending operation region in a second modified example of the third embodiment of the present invention.

FIG. 24 is a diagram showing an example of a change in position of a touch region in the second modified example of the third embodiment of the present invention.

FIG. 25 is a diagram showing an example of a bending mode in the second modified example of the third embodiment of the present invention.

FIG. 26 is a flowchart showing an example of a procedure of a process for determining a bending mode and a bending control value in the second modified example of the third embodiment of the present invention.

FIG. 27 is a diagram showing an example of a bending operation region in a fourth embodiment of the present invention.

FIG. 28 is a diagram showing an example of a bending operation region in a first modified example of the fourth embodiment of the present invention.

FIG. 29 is a flowchart showing an example of a procedure of a process for determining a bending mode and a bending control value in the first modified example of the fourth embodiment of the present invention.

FIG. 30 is a flowchart showing an example of a procedure of a process for determining a bending mode and a bending control value in a second modified example of the fourth embodiment of the present invention.

FIG. 31 is a flowchart showing an example of a procedure of a process for determining a bending mode and a bending control value in a third modified example of the fourth embodiment of the present invention.

FIG. 32 is a diagram showing a method of setting a bending operation region using a mouse according to a fifth embodiment of the present invention.

FIG. 33 is a flowchart showing an example of a procedure of a process for determining a bending mode and a bending control value in the fifth embodiment of the present invention.

FIG. 34 is a flowchart showing an example of a procedure of a process for determining a bending mode and a bending control value in the fifth embodiment of the present invention.

FIG. 35 is a flowchart showing an example of a procedure of a process for determining a bending mode and a bending control value in a first modified example of the fifth embodiment of the present invention.

FIG. 36 is a flowchart showing an example of a procedure of a process for determining a bending mode and a bending control value in a second modified example of the fifth embodiment of the present invention.

FIG. 37 is a flowchart showing an example of a procedure of a process for determining a bending mode and a bending control value in a sixth embodiment of the present invention.

FIG. 38 is a flowchart showing an example of a procedure of a process for determining a bending mode and a bending control value in a first modified example of the sixth embodiment of the present invention.

FIG. 39 is a flowchart showing an example of a procedure of a process for determining a bending mode and a bending control value in a second modified example of the sixth embodiment of the present invention.

FIGS. 40A to 40C are diagrams showing examples of a change in position of a touch region in the second modified example of the sixth embodiment of the present invention.

### DETAILED DESCRIPTION OF THE INVENTION

Hereinafter, embodiments of the present invention will be described with reference to the drawings.

### First embodiment

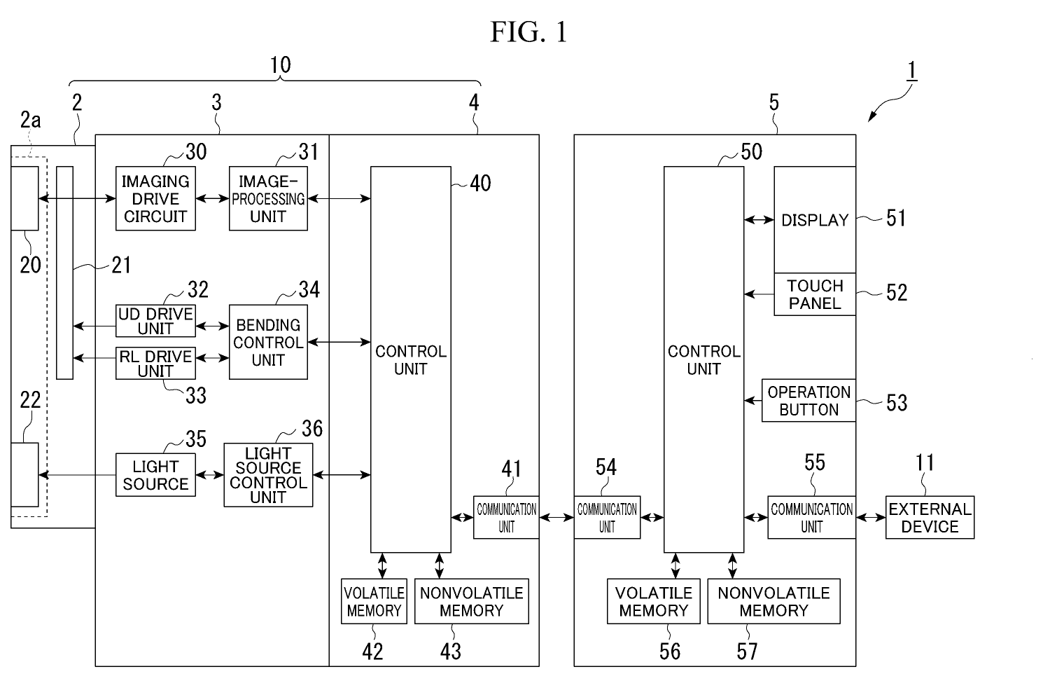

FIG. 1 shows an example of the configuration of an endoscope system 1 according to a first embodiment of the present invention. The endoscope system 1 shown in FIG. 1 includes an insertion unit 2, a scope unit 3, a base unit 4, and a main unit 5. The insertion unit 2, the scope unit 3, and the base unit 4 constitute an endoscope device 10. The main unit 5 is an operation device.

The insertion unit 2 is inserted into a subject which is an observation target. The subject is an industrial product. The insertion unit 2 has a thin and long tube shape and is bendable. A user performs an insertion operation and inserts the insertion unit 2 into the subject. The insertion unit 2 acquires an optical image in the subject. The insertion unit 2 includes an imaging unit 20, a bending portion 21, and an illumination window 22.

The imaging unit 20 is disposed in a distal end portion 2a including the distal end of the insertion unit 2. The imaging unit 20 is an image sensor such as a charge-coupled device (CCD) image sensor or a complementary metal-oxide-semiconductor (CMOS) image sensor. The imaging unit 20 generates an image based on an optical image acquired by the insertion unit 2. The image generated by the imaging unit 20 is output to the scope unit 3.

The bending portion 21 bends the insertion unit 2 upward (U), downward (D), leftward (L), or rightward (R). Alternatively, the bending portion 21 bends the insertion unit 2 up-leftward (UL), up-rightward (UR), down-leftward (DL), or down-rightward (DR).

Illumination light is generated by a light source 35 disposed in the scope unit 3 and is output to the distal end portion 2a via a light guide disposed in the insertion unit 2. The illumination light is emitted to the inside of the subject via the illumination window 22.

The scope unit 3 includes an imaging drive circuit 30, an image-processing unit 31, a UD drive unit 32, an RL drive unit 33, a bending control unit 34, a light source 35, and a light source control unit 36. The base unit 4 includes a control unit 40, a communication unit 41, a volatile memory 42, and a nonvolatile memory 43.

The imaging drive circuit 30 controls the imaging unit 20 such that an image output from the imaging unit 20 is output to the image-processing unit 31. The image-processing unit 31 executes image processing such as noise reduction on the image output from the imaging unit 20 and outputs the image to the control unit 40.

The UD drive unit 32 is connected to a UD bending wire for bending the bending portion 21 in the U direction or the D direction. The UD drive unit 32 includes a motor and bends the bending portion 21 in the U direction or the D direction by pulling the UD bending wire. The RL drive unit 33 is connected to an RL bending wire for bending the bending portion 21 in the R direction or the L direction. The RL drive unit 33 includes a motor and bends the bending portion 21 in the R direction or the L direction by pulling the RL bending wire. The bending control unit 34 controls the UD drive unit 32 and the RL drive unit 33.

The UD drive unit 32 and the RL drive unit 33 can operate simultaneously. For example, the UD drive unit 32 and the RL drive unit 33 can bend the bending portion 21 in the UL direction.

The light source 35 is a light-emitting diode (LED) or the like and generates illumination light. The illumination light is output to the light guide from the light source 35. The light source control unit 36 controls the light source 35.

The control unit 40 controls each unit of the scope unit 3 and the base unit 4. At least one of the control unit 40, the image-processing unit 31, the bending control unit 34, and the light source control unit 36 may be constituted by at least one of a processor and a logic circuit. For example, the processor is at least one of a central processing unit (CPU), a digital signal processor (DSP), and a graphics-processing unit (GPU). For example, the logic circuit is at least one of an application-specific integrated circuit (ASIC) and a field-programmable gate array (FPGA). At least one of the control unit 40, the image-processing unit 31, the bending control unit 34, and the light source control unit 36 may include one or more processors. At least one of the control unit 40, the image-processing unit 31, the bending control unit 34, and the light source control unit 36 may include one or more logic circuits.

A computer of the endoscope system 1 may read a program and execute the read program. The program includes instructions for prescribing an operation of at least one of the control unit 40, the image-processing unit 31, the bending control unit 34, and the light source control unit 36. That is, the function of at least one of the control unit 40, the image-processing unit 31, the bending control unit 34, and the light source control unit 36 may be realized by software.

The program may be provided, for example, using a “computer-readable recording medium” such as a flash memory. The program may be transmitted from a computer storing the program to the endoscope system 1 via a transmission medium or using carrier waves in the transmission medium. The “transmission medium” for transmitting a program is a medium having a function of transmitting information. The medium having a function of transmitting information includes a network (a communication network) such as the Internet and a communication circuit line (a communication line) such as a telephone line. The program may realize some of the above-described functions. The program may be a differential file (a differential program). The above-described functions may be realized in combination of the differential program with a program recorded in advance in the computer.

The communication unit 41 includes a communication circuit and executes wired communication or wireless communication for bending control with the main unit 5. The volatile memory 42 is a random access memory (RAM), a dynamic RAM (DRAM), or the like. The volatile memory 42 stores various kinds of information processed by the control unit 40. The nonvolatile memory 43 is a static RAM (SRAM), an erasable programmable read-only memory (EPROM), an electrically erasable programmable ROM (EEPROM), or a flash memory. The nonvolatile memory 43 may be attachable to and detachable from the base unit 4. The nonvolatile memory 43 stores an image generated by the imaging unit 20 and various kinds of information processed by the control unit 40.

The main unit 5 includes a control unit 50, a display 51, a touch panel 52, an operation button 53, a communication unit 54, a communication unit 55, a volatile memory 56, and a nonvolatile memory 57. The main unit 5 may be an information terminal such as a smartphone or a tablet terminal.

The control unit 50 controls each unit of the main unit 5. The control unit 50 may be constituted by at least one of a processor and a logic circuit. The control unit 50 may include one or more processors. The control unit 50 may include one or more logic circuits. The computer of the endoscope system 1 may read a program and execute the read program. The program includes instructions for prescribing an operation of the control unit 50. That is, the function of the control unit 50 may be realized by software. The program for realizing the function of the control unit 50 may be realized in the same way as the program for realizing the function of the control unit 40 and the like.

The display 51 is a monitor such as a liquid crystal display (LCD). The display 51 displays an image generated by the imaging unit 20. In addition, the display 51 receives an operation for inputting information required for bending control of the insertion unit 2. The touch panel 52 is disposed on a screen of the display 51. A user can input an instruction to change settings of the endoscope system 1, an instruction required for operating the endoscope system 1, and the like to the endoscope system 1 by operating the touch panel 52. Specifically, the instruction required for operating the endoscope system 1 is an operation instruction for bending control, an instruction to operate a menu, or the like.

The touch panel 52 may be disposed at a place other than the screen of the display 51. Specifically, when a smartphone is used as the main unit 5, the touch panel 52 may be disposed on a screen or in a notched part in a display of the smartphone.

A user performs a bending operation using an object on the screen of the touch panel 52. The object in the first embodiment is a finger, a stylus, or the like. In the following description, it is assumed that a user performs the bending operation using the finger.

The operation button 53 receives various instructions from a user. The user can input an instruction related to power supply or illumination to the endoscope system 1 by pressing the operation button 53. The communication unit 54 executes wired communication or wireless communication for bending control with the base unit 4. The communication unit 55 executes wired communication or wireless communication with an external device 11. The external device 11 is a remote controller, a mouse, or the like.

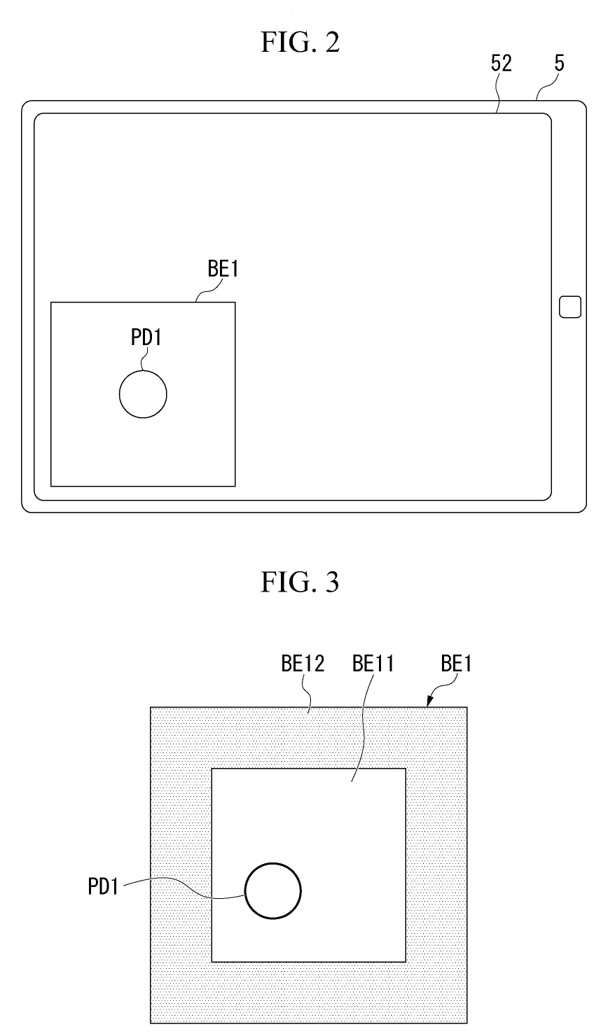

FIG. 2 shows an example of a bending operation region. The control unit 50 sets a bending operation region BE1 shown in FIG. 2 on the touch panel 52. The bending operation region BE1 is a virtual region for receiving the bending operation performed by a user. The user performs a touch operation in the bending operation region BE1 and touches a touch region PD1. When the user performs a slide operation in the bending operation region BE1, the touch region PD1 moves along with movement of the user’s finger. The touch operation and the slide operation correspond to the bending operation. The control unit 50 determines a bending mode in accordance with the position of the touch region PD1. For example, the position of the touch region PD1 corresponds to the center of the touch region PD1. In the example shown in FIG. 2, the bending operation region BE1 is set as part of the screen of the touch panel 52. The bending operation region BE1 is smaller than the half of the screen of the touch panel 52.

The control unit 50 determines a bending control value in accordance with the position of the touch region PD1. The bending control value indicates a bending direction and the amount of bending of the insertion unit 2. In the first embodiment, the control unit 50 determines the amount of bending using any method. The amount of bending in the first embodiment may be a fixed amount.

The control unit 50 may display the bending operation region BE1 on the display 51. Instead of displaying the bending operation region BE1, the bending operation region BE1 may be set in the endoscope system 1. The touch region PD1 is not displayed on the display 51, but the control unit 50 may display the touch region PD1 on the display 51.

In the first embodiment, two or more bending modes for bending control of the insertion unit 2 are prepared. The endoscope system 1 operates in one of the two or more bending modes. A user selects a bending mode by performing a touch operation on the screen of the touch panel 52. The control unit 50 executes bending control of the insertion unit 2 in the bending mode selected by the user.

The two or more bending modes include a coarse movement mode and a minute movement mode. Alternatively, the two or more bending modes include a normal mode and a fine mode. In the following description, it is assumed that the endoscope system 1 executes bending control of the insertion unit 2 in the coarse movement mode or the minute movement mode. The endoscope system 1 can execute bending control of the insertion unit 2 in the normal mode or the fine mode similarly to the following example.

The amount of bending of the insertion unit 2 in the coarse movement mode is greater than the amount of bending of the insertion unit 2 in the minute movement mode. When a bending operation in the normal mode ends, the distal end portion 2a of the insertion unit 2 returns to an initial position. When the bending operation in the fine mode ends, the distal end portion 2a of the insertion unit 2 does not return to the initial position and the insertion unit 2 holds the bent state.

FIG. 3 shows a specific example of the bending operation region BE1. The U direction in the bending operation region BE1 corresponds to the U direction of the insertion unit 2. The D direction in the bending operation region BE1 corresponds to the D direction of the insertion unit 2. The L direction in the bending operation region BE1 corresponds to the L direction of the insertion unit 2. The R direction in the bending operation region BE1 corresponds to the R direction of the insertion unit 2.

The bending operation region BE1 includes a minute movement region BE11 and a coarse movement region BE12. The minute movement region BE11 includes the center of the bending operation region BE1. The coarse movement region BE12 surrounds the minute movement region BE11. For example, the minute movement mode is assigned to the minute movement region BE11, and the coarse movement mode is assigned to the coarse movement region BE12. The coarse movement mode may be assigned to an inner region in the bending operation region BE1, and the minute movement mode may be assigned to an outer region in the bending operation region BE1.

A user performs a touch operation in the bending operation region BE1 and touches a touch region PD1. When the user performs a slide operation in the bending operation region BE1, the touch region PD1 moves with movement of the user’s finger. The touch operation and the slide operation correspond to the bending operation. The control unit 50 determines the bending mode and the bending control value in accordance with the position of the touch region PD1.

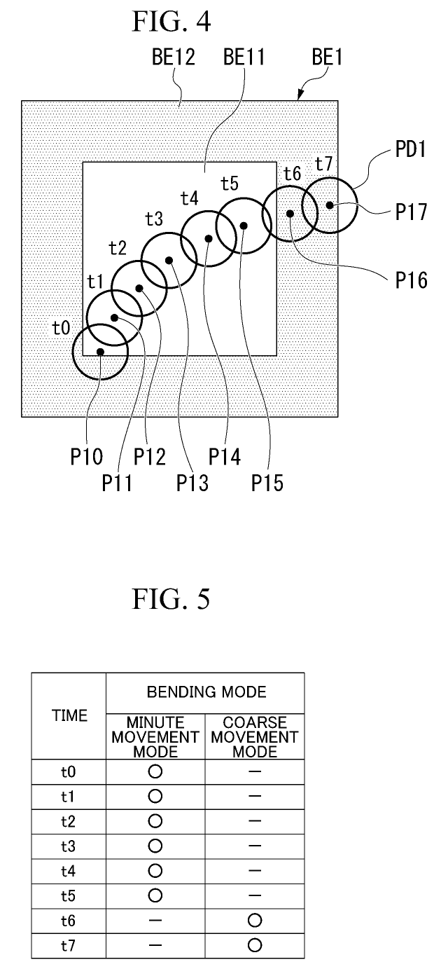

FIG. 4 shows an example of a change in position of the touch region PD1 in the bending operation region BE1. The user touches the bending operation region BE1 at time t0. At this time, the control unit 50 starts receiving position information output from the touch panel 52. The touch region PD1 is located at a position P10. Thereafter, the user moves the finger on the bending operation region BE1 in a state in which the finger has touched the bending operation region BE1. Due to this, the touch region PD1 moves.

The touch region PD1 at times t1, t2, t3, t4, t5, and t6 is located at positions P11, P12, P13, P14, P15, and P16, respectively. The touch region PD1 moves to a position P17 at time t7. The user detaches the finger from the bending operation region BE1 at time t7. At this time, the control unit 50 ends receiving the position information output from the touch panel 52.

FIG. 5 shows an example of the bending mode corresponding to movement of the touch region PD1 shown in FIG. 4. At times t0 to t5, the touch region PD1 is located in the minute movement region BE11. Therefore, the control unit 50 bends the insertion unit 2 in the minute movement mode. At times t6 and t7, the touch region PD1 is located in the coarse movement region BE12. Therefore, the control unit 50 bends the insertion unit 2 in the coarse movement mode.

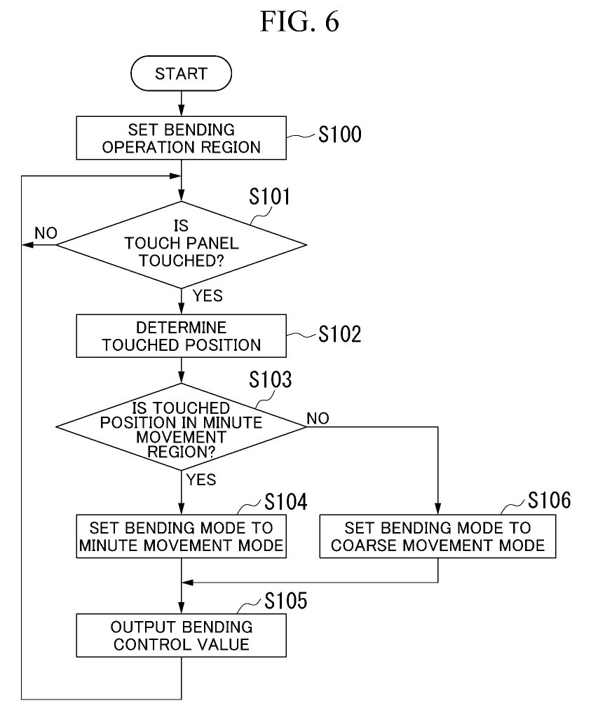

FIG. 6 shows an example of a procedure of a process for determining the bending mode and the bending control value. Operations of the endoscope system 1 will be described by using FIG. 6.

The control unit 50 sets a bending operation region on the touch panel 52 (Step S100). Information of the bending operation region is stored in the volatile memory 56. The control unit 50 reads the information from the volatile memory 56 in accordance with necessity.

After Step S100, the control unit 50 monitors a signal output from the touch panel 52 and determines whether the touch panel 52 is touched (Step S101). When the control unit 50 determines that the touch panel 52 is not touched in Step S101, Step S101 is executed again. The control unit 50 repeats the determination of Step S101 until a user touches the touch panel 52.

When the control unit 50 determines that the touch panel 52 is touched in Step S101, the control unit 50 receives position information output from the touch panel 52 and determines a position on the touch panel 52 touched by the user (Step S102).

After Step S102, the control unit 50 determines whether the position touched by the user is in the minute movement region (Step S103).

When the control unit 50 determines that the position touched by the user is in the minute movement region in Step S103, the control unit 50 sets the bending mode to the minute movement mode. The volatile memory 56 stores mode information indicating the minute movement mode (Step S104).

After Step S104, the control unit 50 determines a bending control value in accordance with the position touched by the user and outputs the bending control value to the communication unit 54 (Step S105). The communication unit 54 transmits the bending control value to the communication unit 41 of the base unit 4. The communication unit 41 receives the bending control value and outputs the bending control value to the control unit 40. The control unit 40 outputs the bending control value to the bending control unit 34.

The bending control unit 34 outputs a bending control value in the UD direction to the UD drive unit 32 and outputs a bending control value in the RL direction to the RL drive unit 33. The UD drive unit 32 bends the bending portion 21 in the U direction or the D direction by pulling the UD bending wire based on the bending control value in the UD direction. Due to this, the insertion unit 2 is bent in the U direction or the D direction. The RL drive unit 33 bends the bending portion 21 in the R direction or the L direction by pulling the RL bending wire based on the bending control value in the RL direction. Due to this, the insertion unit 2 is bent in the R direction or the L direction. When the bending control value is 0, the UD drive unit 32 or the RL drive unit 33 does not bend the bending portion 21. After Step S105, Step S101 is executed.

When the control unit 50 determines that the position touched by the user is not in the minute movement region in Step S103, the control unit 50 sets the bending mode to the coarse movement mode. The volatile memory 56 stores mode information indicating the coarse movement mode (Step S106). After Step S106, Step S105 is executed.

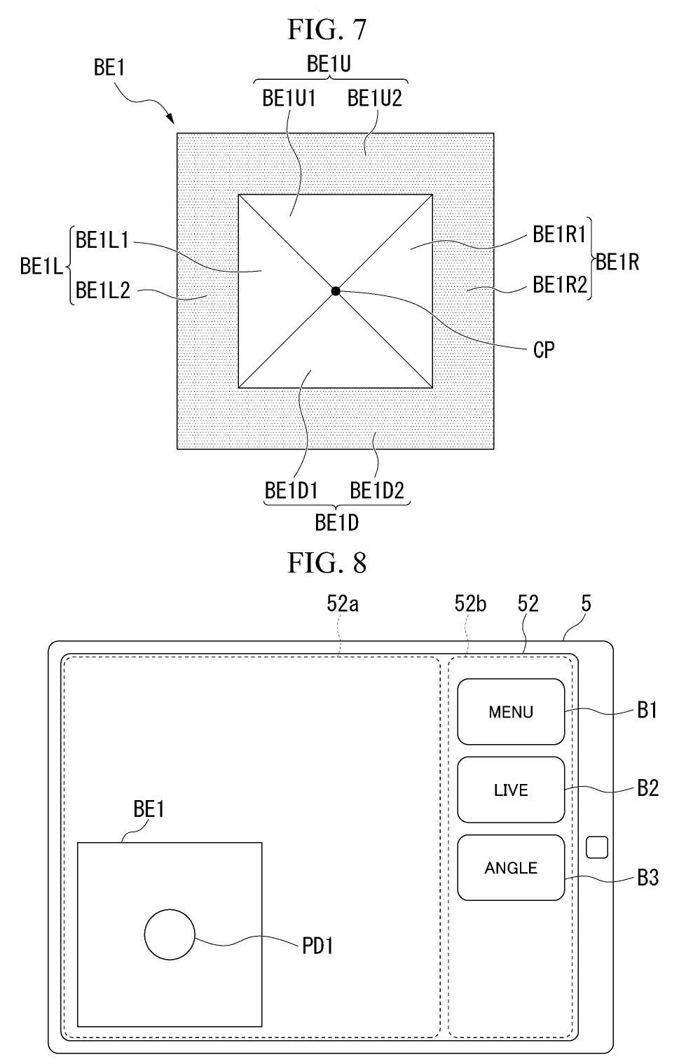

FIG. 7 shows a detailed example of the bending operation region BE1. The bending operation region BE1 includes direction designation regions BE1U, BE1D, BE1R, and BE1L for designating the bending direction of the insertion unit 2. Each direction designation direction is associated with the bending direction of the insertion unit 2.

The direction designation region BE1U includes a minute movement region BE1U1 and a coarse movement region BE1U2. The direction designation region BE1D includes a minute movement region BE1D1 and a coarse movement region BE1D2. The direction designation region BE1R includes a minute movement region BE1R1 and a coarse movement region BE1R2. The direction designation region BE1L includes a minute movement region BE1L1 and a coarse movement region BE1L2. These minute movement regions and these coarse movement regions are arranged to be point-symmetric with respect to the center CP of the bending operation region BE1.

The control unit 50 may display the direction designation regions on the display 51. The direction designation regions may be set in the endoscope system 1 instead of displaying the direction designation regions. The control unit 50 may display the minute movement regions and the coarse movement regions included in the direction designation regions on the display 51. The minute movement regions and the coarse movement regions may be set in the endoscope system 1 instead of displaying the minute movement regions and the coarse movement regions.

The control unit 50 executes the following process in Step S105. The control unit 50 determines a region in which the position touched by the user is included. When the position touched by the user is included in the minute movement region BE1U1 or the coarse movement region BE1U2, the control unit 50 calculates a bending control value for bending the insertion unit 2 in the U direction. When the position touched by the user is included in the minute movement region BE1D1 or the coarse movement region BE1D2, the control unit 50 calculates a bending control value for bending the insertion unit 2 in the D direction. When the position touched by the user is included in the minute movement region BE1R1 or the coarse movement region BE1R2, the control unit 50 calculates a bending control value for bending the insertion unit 2 in the R direction. When the position touched by the user is included in the minute movement region BE1L1 or the coarse movement region BE1L2, the control unit 50 calculates a bending control value for bending the insertion unit 2 in the L direction.

When the position touched by the user is included in the minute movement region BE1U1 or the coarse movement region BE1U2, the control unit 50 may calculate a bending control value for bending the insertion unit 2 in the U direction and bending the insertion unit 2 in the R direction or the L direction. When the position touched by the user is included in the minute movement region BE1D1 or the coarse movement region BE1D2, the control unit 50 may calculate a bending control value for bending the insertion unit 2 in the D direction and bending the insertion unit 2 in the R direction or the L direction. When the position touched by the user is included in the minute movement region BE1R1 or the coarse movement region BE1R2, the control unit 50 may calculate a bending control value for bending the insertion unit 2 in the R direction and bending the insertion unit 2 in the U direction or the D direction. When the position touched by the user is included in the minute movement region BE1L1 or the coarse movement region BE1L2, the control unit 50 may calculate a bending control value for bending the insertion unit 2 in the L direction and bending the insertion unit 2 in the U direction or the D direction.

FIG. 8 shows another example of the bending operation region. The touch panel 52 includes an extended bending operation region 52a and an invalid region 52b. The control unit 50 sets the bending operation region BE1 in the extended bending operation region 52a.

When the position touched by the user is inside the extended bending operation region 52a and outside the bending operation region BE1, the control unit 50 sets the bending mode to the coarse movement mode. The invalid region 52b includes buttons B1, B2, and B3 associated with system settings or function use. When the position touched by the user is included in the invalid region 52b, the control unit 50 executes control other than the bending control based on the position.

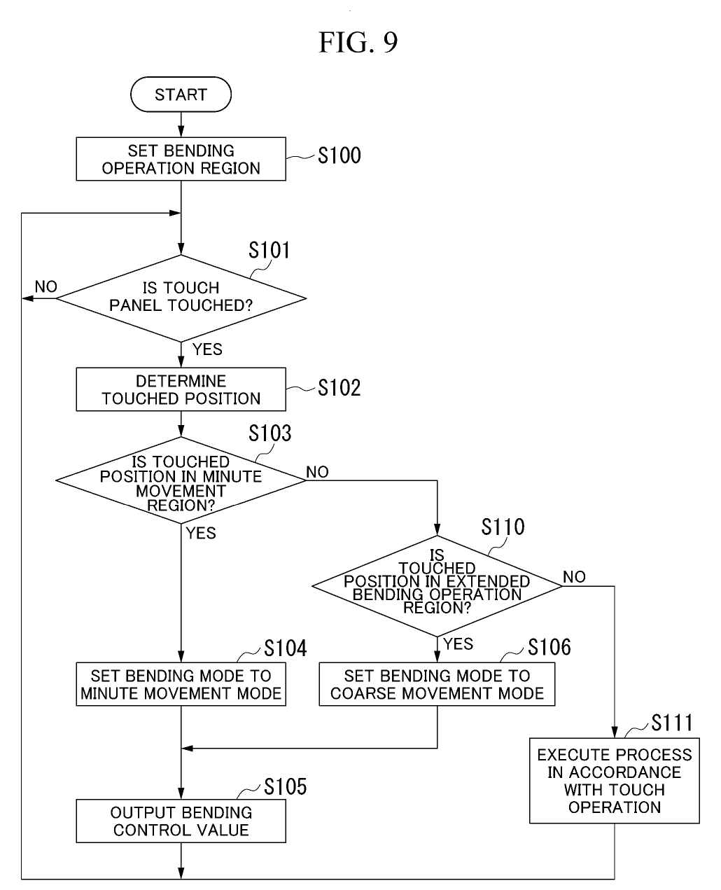

FIG. 9 shows another example of a procedure of a process for determining a bending mode and a bending control value. Operations of the endoscope system 1 will be described by using FIG. 9. The same processes as those shown in FIG. 6 will not be described.

When the control unit 50 determines that the position touched by the user is not in the minute movement region in Step S103, the control unit 50 determines whether the position touched by the user is in the extended bending operation region 52a (Step S110).

When the control unit 50 determines that the position touched by the user is in the extended bending operation region 52a in Step S110, Step S106 is executed. When the control unit 50 determines that the position touched by the user is not in the extended bending operation region 52a in Step S110, the control unit 50 executes a process for control other than the bending control (Step S111). After Step S111, Step S101 is executed.

In the above-described example, the control unit 50 determines the bending mode and the bending control value. In this way, one control unit may perform all the processes for determining the bending mode and the bending control value. Alternatively, two or more control units may cooperatively determine the bending mode and the bending control value. Accordingly, the control unit 50 and the control unit 40 may cooperatively determine the bending mode and the bending control value. The processes executed by the control units can be appropriately changed.

For example, the control unit 50 may output position information output from the touch panel 52 to the communication unit 54. The communication unit 54 may transmit the position information to the communication unit 41. The communication unit 41 may receive the position information and output the received position information to the control unit 40. The control unit 40 may determine the bending mode and the bending control value based on the position indicated by the position information.

The endoscope system 1 according to each aspect of the present invention includes the insertion unit 2 and the control unit 50. The insertion unit 2 is bendable and acquires an optical image in an observation target. The control unit 50 receives, from the touch panel 52 (a device), position information indicating a position in a bending operation region including two or more direction designation regions (such as the direction designation region BE1U) corresponding to two or more bending directions of the insertion unit 2. Each of the two or more direction designation regions includes a first region (such as the minute movement region BE1U1) and a second region (such as the coarse movement region BE1U2) that are different from each other. The control unit 50 bends the insertion unit 2 in a first bending mode (such as the minute movement mode) in the bending direction corresponding to the direction designation region including the first region when the position indicated by the position information is included in the first region. The control unit 50 bends the insertion unit 2 in a second bending mode (such as the coarse movement mode) different from the first bending mode in the bending direction corresponding to the direction designation region including the second region when the position indicated by the position information is included in the second region.

The bending control method according to each aspect of the present invention includes first to third steps. In the first step (Step S102), the control unit 50 receives, from the touch panel 52, position information indicating a position in a bending operation region including two or more direction designation regions corresponding to two or more bending directions of the insertion unit 2. In the second step (Step S104), the control unit 50 bends the insertion unit 2 in the first bending mode in the bending direction corresponding to the direction designation region including the first region when the position indicated by the position information is included in the first region. In the third step (Step S106), the control unit 50 bends the insertion unit 2 in the second bending mode in the bending direction corresponding to the direction designation region including the second region when the position indicated by the position information is included in the second region.

The program according to each aspect of the present invention causes a computer to execute the above-described first to third steps.

Each aspect of the present invention may include the following modified example. The control unit 50 starts receiving the position information at a first timing (time t0). The control unit 50 ends receiving the position information at a second timing (time t7) different from the first timing. The control unit 50 continuously receives the position information between the first timing and the second timing.

Each aspect of the present invention may include the following modified example. The control unit 50 displays the first region and the second region on the display 51.

Each aspect of the present invention may include the following modified example. The control unit 50 sets the bending operation region such that the first region and the second region are arranged to be point-symmetric with respect to a reference position (the center CP).

Each aspect of the present invention may include the following modified example. The endoscope device 10 includes the insertion unit 2. The main unit 5 (the operation device) is separated from the endoscope device 10 and communicates with the endoscope device 10. The main unit 5 includes the touch panel 52 and the control unit 50.

Each aspect of the present invention may include the following modified example. The control unit 50 receives position information indicating a position at which an object touches the touch panel 52.

In the first embodiment, the control unit 50 bends the insertion unit 2 in a direction corresponding to the position indicated by the position information in the bending mode corresponding to the position. Since an operation for executing bending control and an operation for setting a bending mode are shared, the endoscope system 1 can reduce a user’s burden for switching between two or more bending modes.

### First modified example of first embodiment

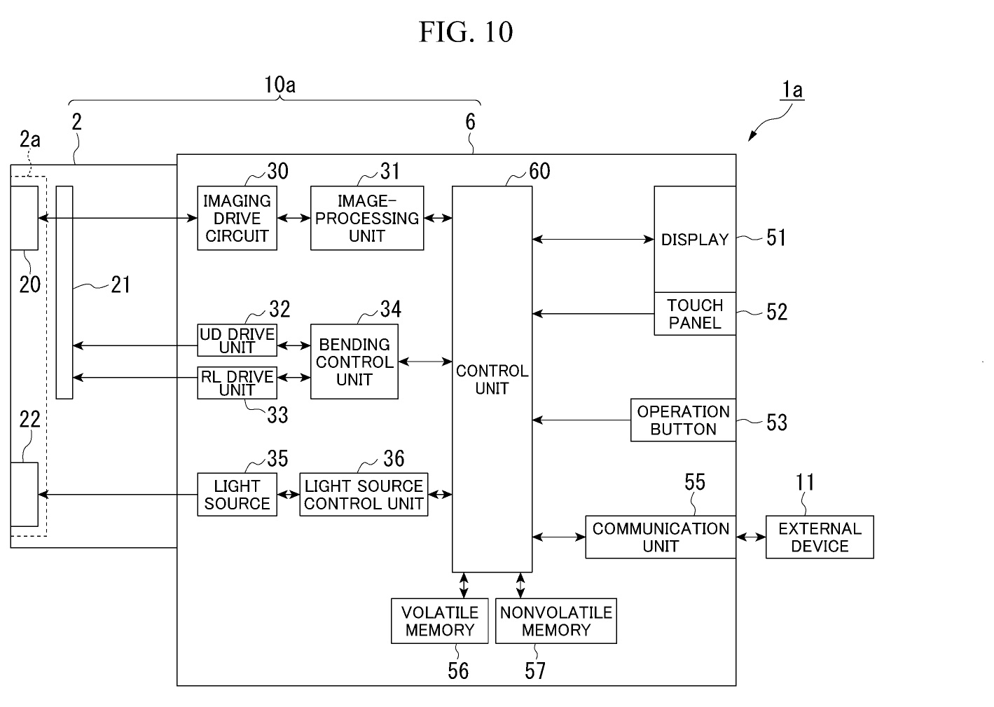

A first modified example of the first embodiment of the present invention will be described. FIG. 10 shows an example of the configuration of an endoscope system 1a according to the first modified example of the first embodiment. The same configuration as that shown in FIG. 1 will not be described.

The endoscope system 1a shown in FIG. 10 includes an insertion unit 2 and a main unit 6. The insertion unit 2 and the main unit 6 constitute an endoscope device 10a.

The insertion unit 2 shown in FIG. 10 is the same as the insertion unit 2 shown in FIG. 1. The main unit 6 includes an imaging drive circuit 30, an image-processing unit 31, a UD drive unit 32, an RL drive unit 33, a bending control unit 34, a light source 35, a light source control unit 36, a display 51, a touch panel 52, an operation button 53, a communication unit 55, a volatile memory 56, a nonvolatile memory 57, and a control unit 60. The same blocks as those shown in FIG. 1 are referred to by the same reference signs as those shown in FIG. 1.

The control unit 60 has both the function of the control unit 40 shown in FIG. 1 and the function of the control unit 50 shown in FIG. 1. The control unit 60 executes the process shown in FIGS. 6 or 9.

Each aspect of the present invention may include the following modified example. The endoscope system 1a includes the endoscope device 10a, and the endoscope device 10a includes the insertion unit 2, the touch panel 52 (a device), and the control unit 60.

In the first modified example of the first embodiment, the endoscope system 1a can reduce a user’s burden for switching between two or more bending modes similarly to the first embodiment.

### Second modified example of first embodiment

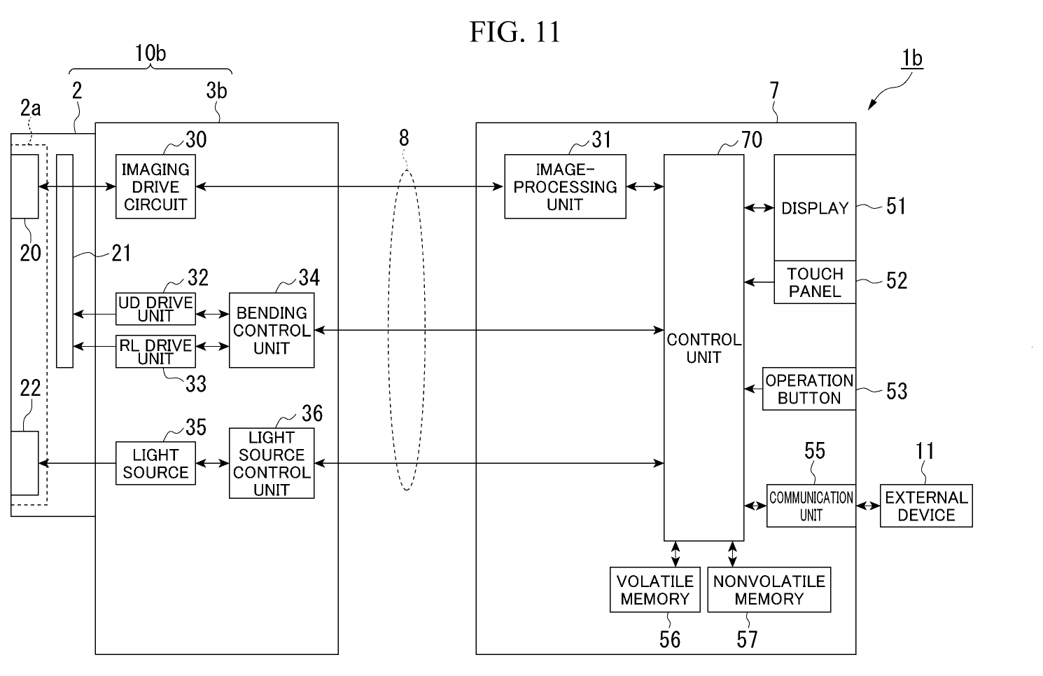

A second modified example of the first embodiment of the present invention will be described. FIG. 11 shows an example of the configuration of an endoscope system 1b according to the second modified example of the first embodiment. The same configuration as that shown in FIG. 1 will not be described.

The endoscope system 1b shown in FIG. 11 includes an insertion unit 2, a scope unit 3b, and a base unit 7. The insertion unit 2 and the scope unit 3b constitute an endoscope device 10b. The scope unit 3b and the base unit 7 are connected to a cable 8.

The insertion unit 2 shown in FIG. 11 is the same as the insertion unit 2 shown in FIG. 1. The scope unit 3b shown in FIG. 11 is the same as the scope unit 3 shown in FIG. 1 except that the image-processing unit 31 is not included. The base unit 7 includes an image-processing unit 31, a display 51, a touch panel 52, an operation button 53, a communication unit 55, a volatile memory 56, a nonvolatile memory 57, and a control unit 70. The same blocks as those shown in FIG. 1 are referred to by the same reference signs as those shown in FIG. 1.

The control unit 70 has both the function of the control unit 40 shown in FIG. 1 and the function of the control unit 50 shown in FIG. 1. The control unit 70 executes the process shown in FIGS. 6 or 9.

In the second modified example of the first embodiment, the endoscope system 1b can reduce a user’s burden for switching between two or more bending modes similarly to the first embodiment.

### Second embodiment

A second embodiment of the present invention will be described. In the second embodiment, the endoscope system 1 shown in FIG. 1 is used. The endoscope system 1a shown in FIG. 10 or the endoscope system 1b shown in FIG. 11 may be used.

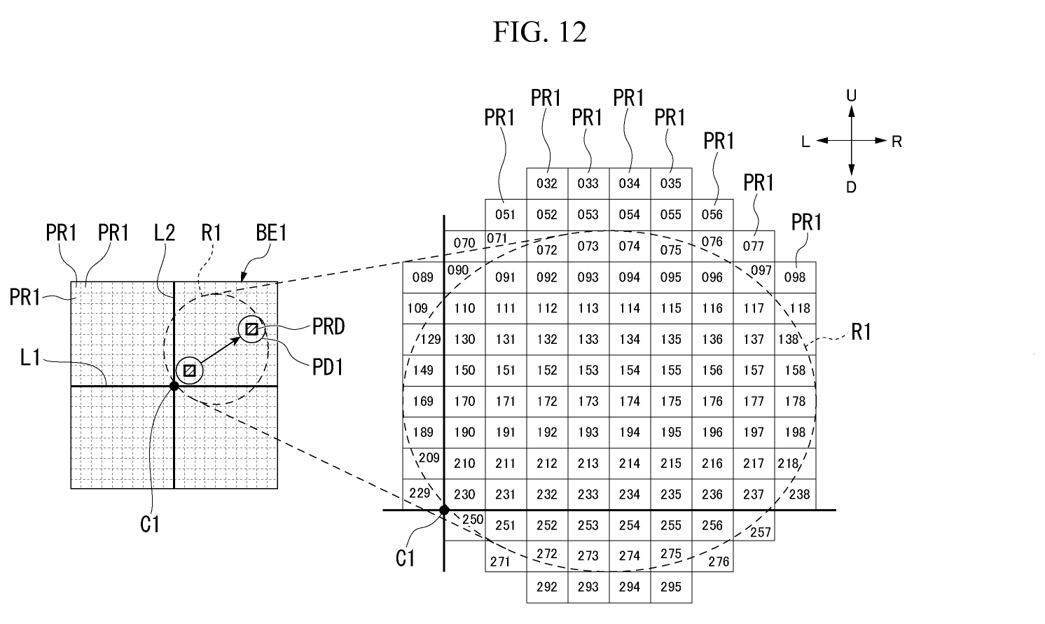

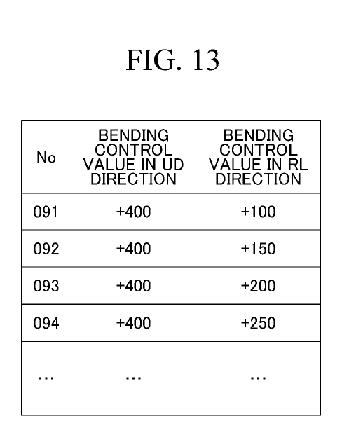

FIG. 12 shows an example of the configuration of a bending operation region BE1 in the second embodiment. For example, the bending operation region BE1 has a square shape. The U direction in the bending operation region BE1 corresponds to the U direction of the insertion unit 2. The D direction in the bending operation region BE1 corresponds to the D direction of the insertion unit 2. The L direction in the bending operation region BE1 corresponds to the L direction of the insertion unit 2. The R direction in the bending operation region BE1 corresponds to the R direction of the insertion unit 2.

The bending operation region BE1 includes two or more square sub-regions PR1. The number of sub-regions PR1 is any integer greater than or equal to 2. These sub-regions PR1 are arranged in a matrix. The number of rows and the number of columns of the matrix are two or more. The number of sub-regions PR1 may be four or more.

Each sub-region PR1 is associated with a bending control value that is set in accordance with the position of the sub-region PR1. The bending control value includes a bending control value for bending the insertion unit 2 in the U direction or the D direction and a bending control value for bending the insertion unit 2 in the R direction or the L direction.

The bending operation region BE1 includes the direction designation regions BE1U, BE1D, BE1R, and BE1L shown in FIG. 7. These direction designation regions are not shown in FIG. 12. Each direction designation region includes a minute movement region and a coarse movement region. Each of the minute movement region and the coarse movement region includes two or more sub-regions PR1.

The bending operation region BE1 is divided into four regions by a straight line L1 and a straight line L2. The straight line L1 passes through the center C1 of the bending operation region BE1 and is parallel to the RL direction. The straight line L2 passes through the center C1 and is parallel to the UD direction. The straight line L1 and the straight line L2 may be displayed on the display 51 or may not be displayed on the display 51.

The sub-regions PR1 in the right-up region out of the four regions into which the bending operation region has been divided by the straight line L1 and the straight line L2 are associated with the bending control value for bending the insertion unit 2 in the UR direction. The sub-regions PR1 in the left-up region out of the four regions are associated with the bending control value for bending the insertion unit 2 in the UL direction. The sub-regions PR1 in the right-down region out of the four regions are associated with the bending control value for bending the insertion unit 2 in the DR direction. The sub-regions PR1 in the left-down region out of the four regions are associated with the bending control value for bending the insertion unit 2 in the DL direction.

The nonvolatile memory 57 stores a lookup table (LUT) including two or more bending control values. Each sub-region PR1 is associated with a table number of the LUT. The table numbers of the sub-regions PR1 in a region R1 and in the vicinity thereof are shown in FIG. 12.

Bending control values corresponding to a small amount of bending are associated with the sub-regions PR1 close to the center C1. Bending control values corresponding to a large amount of bending are associated with the sub-regions PR1 far from the center C1. The control unit 50 bends the insertion unit 2 by a first amount of bending according to a first bending control value associated with a first sub-region. The control unit 50 bends the insertion unit 2 by a second amount of bending according to a second bending control value associated with a second sub-region. The distance between the second sub-region and the center C1 is greater than that between the first sub-region and the center C1. The second amount of bending is greater than the first amount of bending. A position serving as a reference for comparison of the amounts of bending is not limited to the center C1.

As the sub-region PR1 becomes farther in the U direction from the center C1, the bending control value in the U direction becomes larger. As the sub-region PR1 becomes farther in the D direction from the center C1, the bending control value in the D direction becomes larger. As the sub-region PR1 becomes farther in the R direction from the center C1, the bending control value in the R direction becomes larger. As the sub-region PR1 becomes farther in the L direction from the center C1, the bending control value in the L direction becomes larger.

FIG. 13 shows an example of the bending control values associated with the sub-regions PR1. The table number of each sub-region PR1, the bending control value in the UD direction, and the bending control value in the RL direction are shown.

Each bending control value is positive or negative. When the bending control value in the UD direction is positive, the UD drive unit 32 bends the bending portion 21 in the U direction. When the bending control value in the UD direction is negative, the UD drive unit 32 bends the bending portion 21 in the D direction. When the bending control value in the RL direction is positive, the RL drive unit 33 bends the bending portion 21 in the R direction. When the bending control value in the RL direction is negative, the RL drive unit 33 bends the bending portion 21 in the L direction.

The shape of the bending operation region BE1 is not limited to a square shape. The bending operation region BE1 may have a quadrangular shape such as a rectangular shape. The bending operation region BE1 may have a circular shape or an elliptical shape. The shape of each sub-region PR1 is not limited to a square shape. Each sub-region PR1 may have a quadrangular shape such as a rectangular shape. Each sub-region PR1 may have any shape in contact with a circumferential edge of another sub-region PR1.

As shown in FIG. 12, a user moves the touch region PD1 in the bending operation region BE1. The touch panel 52 generates position information indicating the position of the touch region PD1 and outputs the position information to the control unit 50. The control unit 50 receives the position information and identifies a sub-region PRD corresponding to the position indicated by the position information. The center of the touch region PD1 is included in the sub-region PRD.

When a sub-region is included in the minute movement region BE31, the control unit 50 acquires a bending control value associated with the sub-region from the LUT. The control unit 50 corrects the bending control value using a correction coefficient (a weight) that is set for the minute movement mode. For example, the control unit 50 acquires the corrected bending control value by multiplying the bending control value by 1/N. N is an integer greater than or equal to 2. The correction coefficient is 1/N.

When a sub-region is included in the coarse movement region BE32, the control unit 50 acquires a bending control value associated with the sub-region from the LUT. The control unit 50 corrects the bending control value using a correction coefficient that is set for the coarse movement mode. For example, the control unit 50 acquires the corrected bending control value by multiplying the bending control value by N. The correction coefficient is N. The correction coefficient set for the coarse movement mode is greater than the correction coefficient set for the minute movement mode. The nonvolatile memory 57 stores the correction coefficients for the bending modes.

When the normal mode and the fine mode are used instead of the minute movement mode and the coarse movement mode, the control unit 50 need not correct the bending control values acquired from the LUT.

The control unit 50 outputs the corrected bending control values to the communication unit 54. The same process as that described above is executed, and the bending control unit 34 outputs the bending control value in the UD direction to the UD drive unit 32 and outputs the bending control value in the RL direction to the RL drive unit 33. The UD drive unit 32 bends the bending portion 21 in the U direction or the D direction. The RL drive unit 33 bends the bending portion 21 in the R direction or the L direction.

The control unit 50 acquires the bending control values from the LUT instead of calculating the distance between the position of the touch region PD1 and the center C1 of the bending operation region BE1. Therefore, the endoscope system 1 can simplify the processes required for bending control of the insertion unit 2 and reduce a process load.

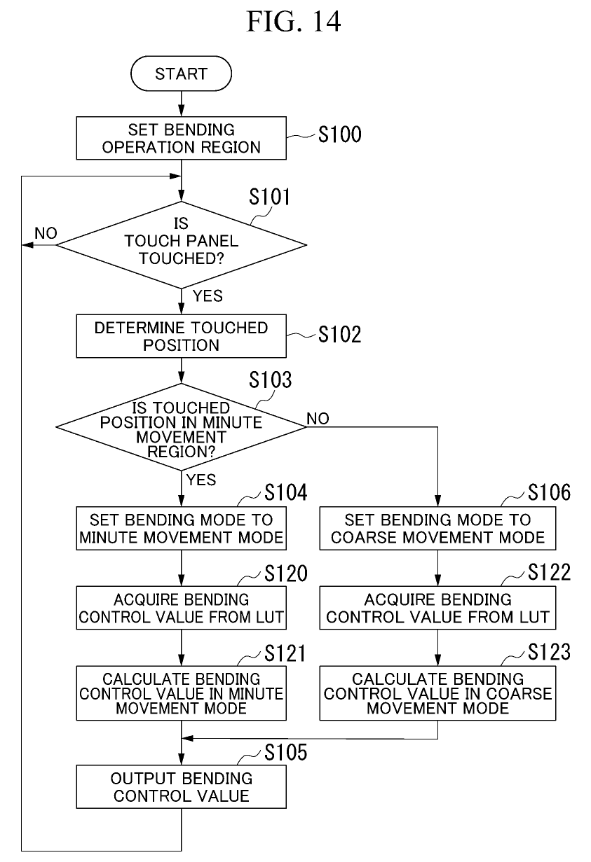

FIG. 14 shows an example of a procedure of a process for determining a bending mode and a bending control value. Operations of the endoscope system 1 will be described by using FIG. 14. The same processes as those shown in FIG. 6 will not be described.

The control unit 50 sets a bending operation region on the touch panel 52 in Step S100. At this time, the control unit 50 associates positions in the bending operation region with table numbers of the LUT.

After Step S104, the control unit 50 identifies a table number corresponding to a position touched by a user. The table number corresponds to a sub-region. The control unit 50 acquires a bending control value associated with that table number from the LUT (Step S120).

After Step S120, the control unit 50 corrects the acquired bending control value using a method corresponding to a bending mode indicated by mode information. For example, the control unit 50 multiplies the bending control value by 1/N. By doing this, the control unit 50 calculates a bending control value in the minute movement mode (Step S121). After Step S121, Step S105 is executed.

After Step S106, the control unit 50 identifies the table number corresponding to the position touched by the user. The table number corresponds to a sub-region. The control unit 50 acquires the bending control value associated with the table number from the LUT (Step S122).

After Step S122, the control unit 50 corrects the acquired bending control value using a method corresponding to the bending mode indicated by the mode information. For example, the control unit 50 multiplies the bending control value by N. By doing this, the control unit 50 calculates a bending control value in the coarse movement mode (Step S123). After Step S123, Step S105 is executed.

Each aspect of the present invention may include the following modified example. Each of the first region (such as the minute movement region BE1U1) and the second region (such as the coarse movement region BE1U2) included in a direction designation region (such as the direction designation region BE1U) includes two or more sub-regions PR1. The control unit 50 bends the insertion unit 2 based on the bending control value in the sub-region PR1 corresponding to the position indicated by the position information output from the touch panel 52 out of the two or more sub-regions PR1.

Each aspect of the present invention may include the following modified example. The control unit 50 acquires, from the nonvolatile memory 57 (a storage medium), a bending control value associated with the sub-region PR1 corresponding to the position indicated by the position information.

In the second embodiment, the control unit 50 acquires a bending control value associated with a sub-region corresponding to a position designated in the bending operation region from the LUT. Since the control unit 50 determines the bending control value using a simple method, the endoscope system 1 can reduce a process load required for bending control of the insertion unit 2.

### First modified example of second embodiment

A first modified example of the second embodiment of the present invention will be described. FIG. 15 shows another example of the bending operation region. The control unit 50 sets a bending operation region BE2 shown in FIG. 15 on the touch panel 52. The bending operation region BE2 includes direction designation regions BE2U, BE2D, BE2R, BE2L, BE2UR, BE2UL, BE2DR, and BE2DL for designating the bending direction of the insertion unit 2.

The direction designation region BE2U includes a minute movement region BE2U1 and a coarse movement region BE2U2. The direction designation region BE2D includes a minute movement region BE2D1 and a coarse movement region BE2D2. The direction designation region BE2R includes a minute movement region BE2R1 and a coarse movement region BE2R2. The direction designation region BE2L includes a minute movement region BE2L1 and a coarse movement region BE2L2. The direction designation region BE2UR includes a minute movement region BE2UR1 and a coarse movement region BE2UR2. The direction designation region BE2UL includes a minute movement region BE2UL1 and a coarse movement region BE2UL2. The direction designation region BE2DR includes a minute movement region BE2DR1 and a coarse movement region BE2DR2. The direction designation region BE2DL includes a minute movement region BE2DL1 and a coarse movement region BE2DL2. These minute movement regions and these coarse movement regions are arranged to be point-symmetric with respect to the center of the bending operation region BE2.

Each of the direction designation directions includes two or more sub-regions. Each of the minute movement region and the coarse movement region in each direction designation region includes one or more sub-regions. Each sub-region is associated with a bending control value that is set in accordance with the position of the sub-region. The nonvolatile memory 57 stores an LUT including the bending control values associated with the sub-regions. The bending control values included in the LUT are the same as those included in the LUT in the second embodiment.

The minute movement mode is assigned to a minute movement region in each direction designation region. The coarse movement mode is assigned to a coarse movement region in each direction designation region. When a user touches a position in the minute movement region, the control unit 50 acquires a bending control value associated with a sub-region at the position from the LUT. The control unit 50 corrects the bending control value using a correction coefficient that is set for the minute movement mode. When the user touches a position in the coarse movement region, the control unit 50 acquires a bending control value associated with a sub-region at the position from the LUT. The control unit 50 corrects the bending control value using a correction coefficient that is set for the coarse movement mode. The correction coefficient set for the coarse movement mode is different from that set for the minute movement mode.

When the endoscope system 1 bends the insertion unit 2 in the U direction, the UD drive unit 32 operates. When the endoscope system 1 bends the insertion unit 2 in the UR direction, the UD drive unit 32 and the RL drive unit 33 operate. In order to make an operational feeling in accordance with the bending direction of the insertion unit 2 uniform, the correction coefficient in the same bending mode varies depending on the bending direction. That is, a correction coefficient for bending the insertion unit 2 in a direction with a small diagonal component is different from that for bending the insertion unit 2 in a direction with a large diagonal component.

For example, the correction coefficient in the minute movement region BE2U1, the correction coefficient in the minute movement region BE2D1, the correction coefficient in the minute movement region BE2R1, and the correction coefficient in the minute movement region BE2L1 are the same. The correction coefficient in the minute movement region BE2UR1, the correction coefficient in the minute movement region BE2UL1, the correction coefficient in the minute movement region BE2DR1, and the correction coefficient in the minute movement region BE2DL1 are the same. On the other hand, the correction coefficient in the minute movement region BE2UR1 is different from the correction coefficient in the minute movement region BE2U1.

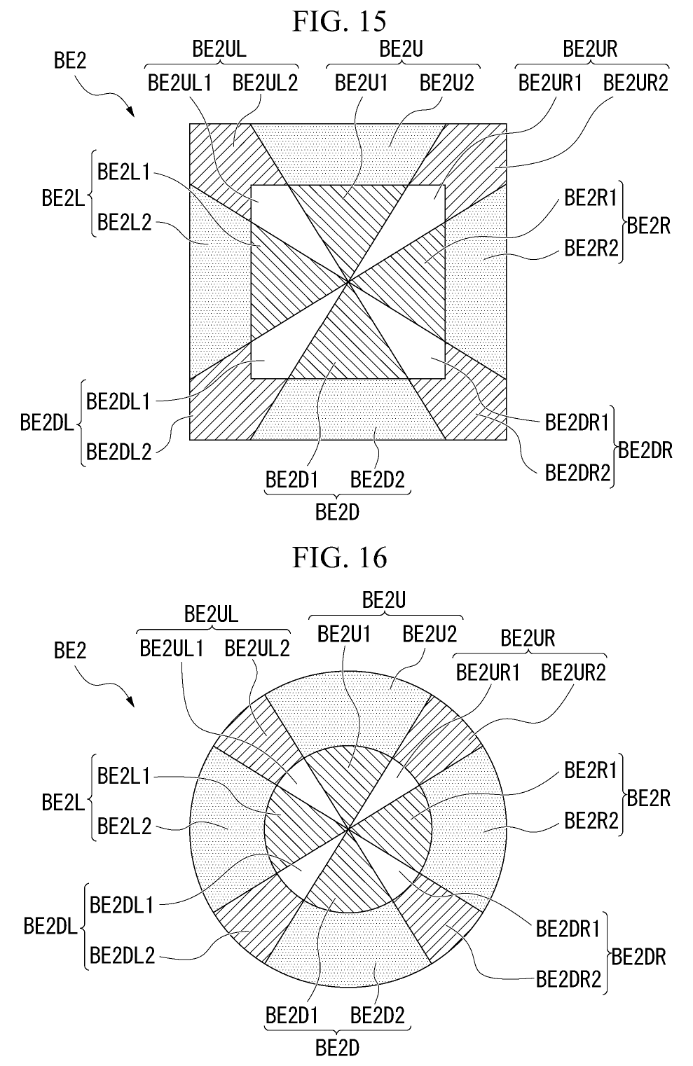

FIG. 16 shows another example of the bending operation region BE2. The shape of each region included in the bending operation region BE2 is different from that of each region included in the bending operation region BE2 shown in FIG. 15.

The number of regions into which the bending operation region has been divided is any number greater than or equal to 2. The shape of the divided regions is arbitrary. The bending modes assigned to the divided regions are arbitrary.

In the first modified example of the second embodiment, the bending operation region is divided into many regions, and correction coefficients corresponding to the bending direction of the insertion unit 2 are assigned to the regions. Therefore, it is possible to obtain a uniform operational feeling regardless of the bending direction of the insertion unit 2.

### Second modified example of second embodiment

A second modified example of the second embodiment of the present invention will be described. In the second modified example of the second embodiment, the control unit 50 acquires a bending control value based on the distance between a position indicated by position information output from the touch panel 52 and a reference position preset in the bending operation region.

The control unit 50 sets the bending operation region BE1 shown in FIG. 7 on the touch panel 52. When a user touches a position in the bending operation region BE1, the control unit 50 calculates the distance between the position touched by the user and a reference position. For example, the reference position is the center of the bending operation region. The control unit 50 calculates the bending control value in accordance with the calculated distance. The control unit 50 corrects the bending control value in accordance with the position touched by the user. The method of correcting the bending control value is the same as that in the second embodiment.

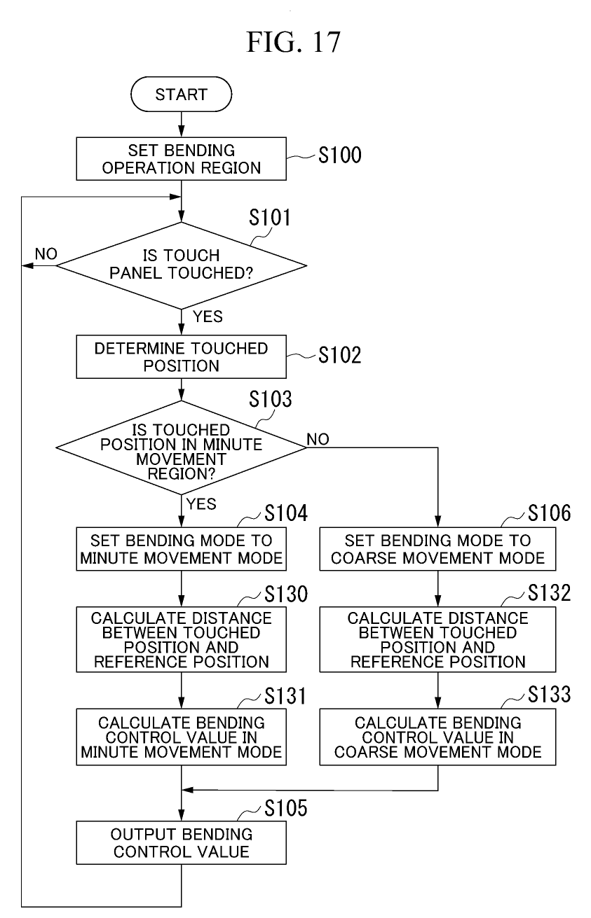

FIG. 17 shows an example of a procedure of a process for determining a bending mode and a bending control value. Operations of the endoscope system 1 will be described by using FIG. 17. The same processes as those shown in FIG. 6 will not be described.

After Step S104, the control unit 50 calculates the distance between the position touched by the user and the reference position (Step S130).

After Step S130, the control unit 50 calculates the bending control value in accordance with the calculated distance. For example, the nonvolatile memory 57 stores an LUT including two or more distances and bending control values associated with the distances. The control unit 50 acquires a bending control value associated with the calculated distance from the LUT. The control unit 50 may acquire the bending control value based on both a direction determined based on both the position touched by the user and the reference position and the calculated distance without referring to the LUT. The control unit 50 corrects the acquired bending control value using a method corresponding to the bending mode indicated by mode information. For example, the control unit 50 multiplies the bending control value by 1/N. By doing this, the control unit 50 calculates a bending control value in the minute movement mode (Step S131). After Step S131, Step S105 is executed.

After Step S106, the control unit 50 calculates the distance between the position touched by the user and the reference position (Step S132).

After Step S132, the control unit 50 calculates a bending control value in accordance with the calculated distance. For example, the control unit 50 acquires a bending control value associated with the calculated distance from the LUT. The control unit 50 corrects the acquired bending control value using the method corresponding to the bending mode indicated by the mode information. For example, the control unit 50 multiplies the bending control value by N. By doing this, the control unit 50 calculates a bending control value in the coarse movement mode (Step S133). After Step S133, Step S105 is executed.

The user may perform a slide operation. The reference position may be a position at which the user’s finger has been detached from the bending operation region BE1. The control unit 50 may determine the bending direction in accordance with the position touched by the user. Alternatively, the control unit 50 may determine the bending direction in accordance with the position at which the user’s finger has been detached from the bending operation region BE1.

Each aspect of the present invention may include the following modified example. The control unit 50 acquires a bending control value based on the distance between a position indicated by position information output from the touch panel 52 and the reference position preset in the bending operation region.

### Third embodiment

A third embodiment of the present invention will be described. In the third embodiment, the endoscope system 1 shown in FIG. 1 is used. The endoscope system 1a shown in FIG. 10 or the endoscope system 1b shown in FIG. 11 may be used.

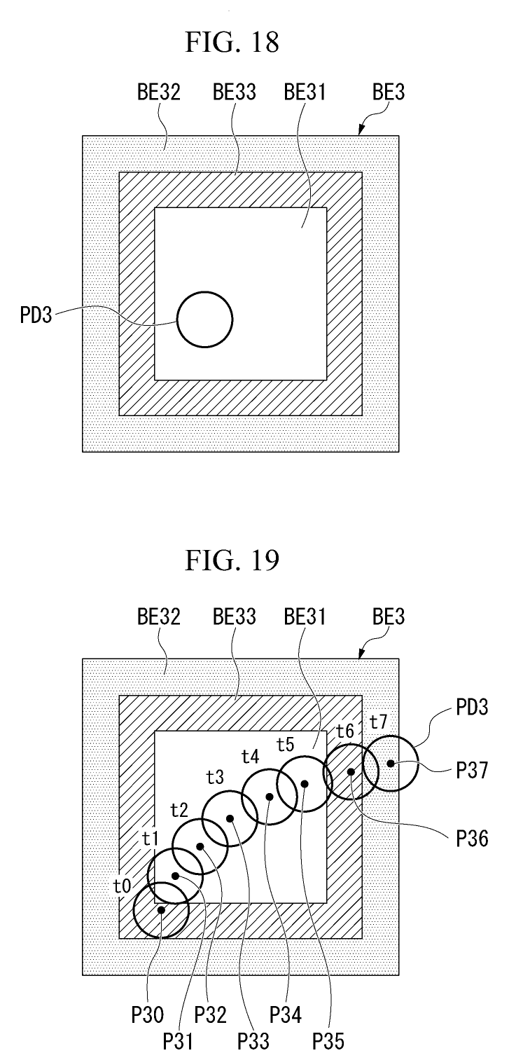

FIG. 18 shows an example of a bending operation region in the third embodiment. The control unit 50 sets a bending operation region BE3 shown in FIG. 18 on the touch panel 52.

The bending operation region BE3 includes a minute movement region BE31, a coarse movement region BE32, and a common region BE33. The minute movement region BE31 includes the center of the bending operation region BE3. The common region BE33 surrounds the minute movement region BE31. The coarse movement region BE32 surrounds the common region BE33. The common region BE33 is disposed between the minute movement region BE31 and the coarse movement region BE32. For example, the minute movement mode is assigned to the minute movement region BE31, and the coarse movement mode is assigned to the coarse movement region BE32. The coarse movement mode may be assigned to an inner region of the bending operation region BE3, and the minute movement mode may be assigned to an outer region in the bending operation region BE3. The minute movement mode or the coarse movement mode is assigned to the common region BE33 according to a bending operation performed by a user.

The user performs a touch operation in the bending operation region BE3 and touches a touch region PD3. When the user performs a slide operation in the bending operation region BE3, the touch region PD3 moves along with movement of the user’s finger. The touch operation and the slide operation correspond to the bending operation. The control unit 50 determines a bending mode and a bending control value in accordance with the position of the touch region PD3.

For example, when the user moves the touch region PD3 from a position in the minute movement region BE31 or the common region BE33, the minute movement mode is assigned to the common region BE33. In the other cases, the coarse movement mode is assigned to the common region BE33.

The bending operation region BE3 includes the same direction designation regions as the direction designation regions BE1U, BE1D, BE1R, and BE1L shown in FIG. 7. These direction designation regions are not shown in FIG. 18. Each direction designation region includes a minute movement region and a coarse movement region. Each direction designation region includes a common region.

FIG. 19 shows an example of a change in position of the touch region PD3 in the bending operation region BE3. The user touches the bending operation region BE3 at time t0. At this time, the control unit 50 starts receiving position information output from the touch panel 52. The touch region PD3 is located at a position P30. Thereafter, the user moves the finger on the bending operation region BE3 in a state in which the finger has touched the bending operation region BE3. Due to this, the touch region PD3 moves.

The touch region PD3 at times t1, t2, t3, t4, t5, and t6 is located at positions P31, P32, P33, P34, P35, and P36, respectively. The touch region PD3 moves to a position P37 at time t7. The user detaches the finger from the bending operation region BE3 at time t7. At this time, the control unit 50 ends receiving the position information output from the touch panel 52.

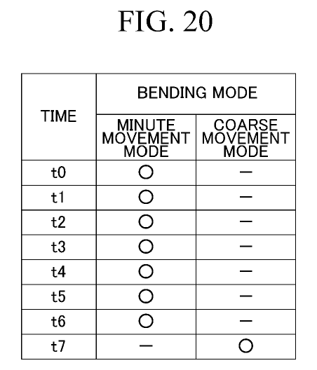

FIG. 20 shows an example of a bending mode corresponding to movement of the touch region PD3 shown in FIG. 19. At time t0, the touch region PD3 is located in the common region BE33. The control unit 50 bends the insertion unit 2 in the minute movement mode. At times t1 to t5, the touch region PD3 is located in the minute movement region BE31. Therefore, the control unit 50 bends the insertion unit 2 in the minute movement mode. At time t6, the touch region PD3 is located in the common region BE33. Since the touch region PD3 moves from the bending operation region B31 to the common region BE33, the control unit 50 bends the insertion unit 2 in the minute movement mode. At time t7, the touch region PD3 is located in the coarse movement region BE32. Therefore, the control unit 50 bends the insertion unit 2 in the coarse movement mode.

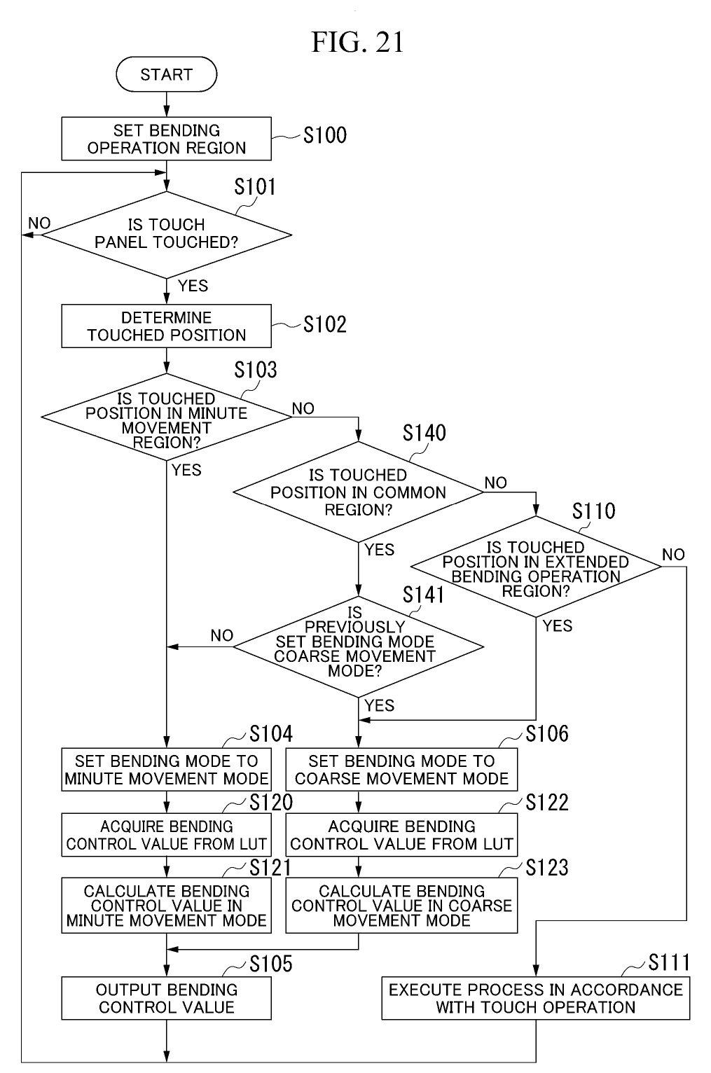

FIG. 21 shows an example of a procedure of a process for determining a bending mode and a bending control value. Operations of the endoscope system 1 will be described by using FIG. 21. The same processes as those shown in FIG. 9 or 14 will not be described.

The volatile memory 56 stores information indicating a previously set bending mode. When the control unit 50 determines that the touch panel 52 is not touched in Step S101, Step S101 is executed again. At this time, the information indicating a previously set bending mode is reset.

When the control unit 50 determines that the position touched by the user is not in the minute movement region in Step S103, the control unit 50 determines whether the position touched by the user is in the common region (Step S140).

When the control unit 50 determines that the position touched by the user is in the common region in Step S140, the control unit 50 determines whether the previously set bending mode is the coarse movement mode (Step S141).

When the control unit 50 determines that the previously set bending mode is the minute movement mode or when the control unit 50 determines that the information indicating the previously set bending mode has been reset, Step S104 is executed. The information indicating the previously set bending mode indicates the minute movement mode or has been reset. When the control unit 50 determines that the previously set bending mode is the coarse movement mode, Step S106 is executed. The information indicating the previously set bending mode indicates the coarse movement mode.

When the control unit 50 determines that the position touched by the user is not in the common region in Step S140, Step S110 is executed.

In the example shown in FIG. 21, the method of determining a bending control value is the same as that in the second embodiment. Any method can be used to determine a bending control value in the third embodiment.

Each aspect of the present invention may include the following modified example. Each of two or more direction designation regions (such as the direction designation region BE1U) includes a third region (a common region) that is different from both the first region (such as the minute movement region BE1U1) and the second region (such as the coarse movement region BE1U2). When the position indicated by the position information output from the touch panel 52 is included in the third region, the control unit 50 bends the insertion unit 2 in the first bending mode (such as the minute movement mode) or a second bending mode (such as the coarse movement mode) in accordance with a position indicated by position information that has been previously received.

Each aspect of the present invention may include the following modified example. The third region is located between the first region and the second region. When the position indicated by the position information that has been previously received is included in the first region, the control unit 50 bends the insertion unit 2 in the first bending mode. When the position indicated by the position information that has been previously received is included in the second region, the control unit 50 bends the insertion unit 2 in the second bending mode.

In the third embodiment, when the bending mode is set to the minute movement mode, the minute movement mode is assigned to the common region. On the other hand, when the bending mode is set to the coarse movement mode, the coarse movement mode is assigned to the common region. Since the bending operation region assigned to the bending mode is widened, it is possible to improve a user’s operability.

### First modified example of third embodiment

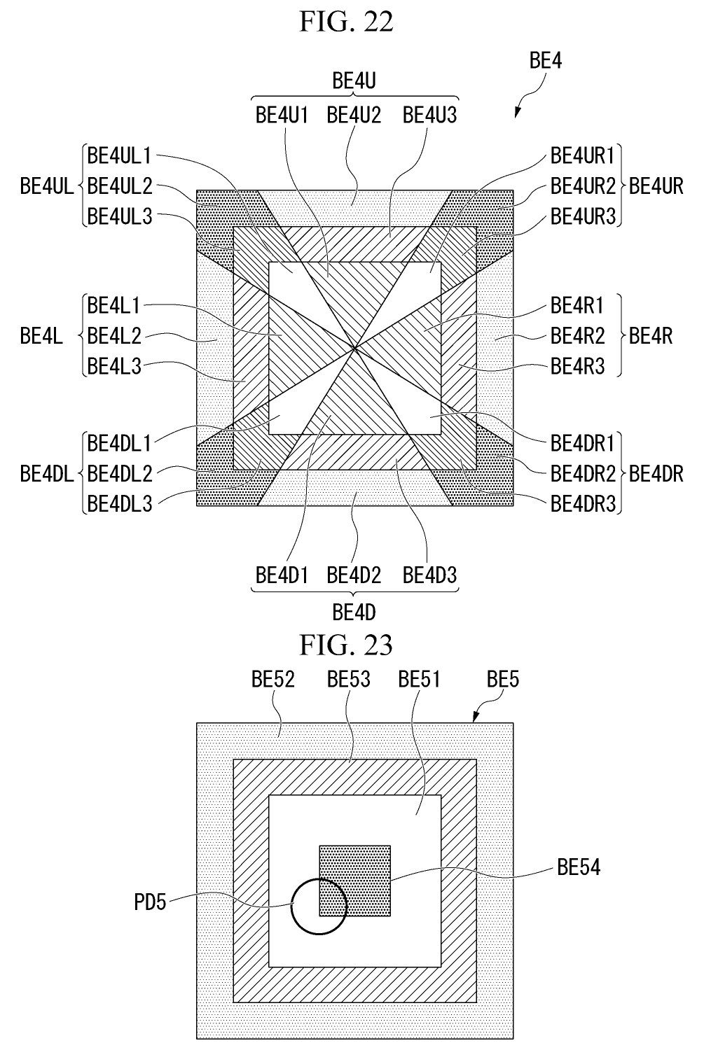

A first modified example of the third embodiment of the present invention will be described. FIG. 22 shows another example of the bending operation region. The control unit 50 sets a bending operation region BE4 shown in FIG. 22 on the touch panel 52. The bending operation region BE4 includes direction designation regions BE4U, BE4D, BE4R, BE4L, BE4UR, BE4UL, BE4DR, and BE4DL for designating the bending direction of the insertion unit 2.

The direction designation region BE4U includes a minute movement region BE4U1, a coarse movement region BE4U2, and a common region BE4U3. The direction designation region BE4D includes a minute movement region BE4D1, a coarse movement region BE4D2, and a common region BE4D3. The direction designation region BE4R includes a minute movement region BE4R1, a coarse movement region BE4R2, and a common region BE4R3. The direction designation region BE4L includes a minute movement region BE4L1, a coarse movement region BE4L2, and a common region BE4L3. The direction designation region BE4UR includes a minute movement region BE4UR1, a coarse movement region BE4UR2, and a common region BE4UR3. The direction designation region BE4UL includes a minute movement region BE4UL1, a coarse movement region BE4UL2, and a common region BE4UL3. The direction designation region BE4DR includes a minute movement region BE4DR1, a coarse movement region BE4DR2, and a common region BE4DR3. The direction designation region BE4DL includes a minute movement region BE4DL1, a coarse movement region BE4DL2, and a common region BE4DL3. These minute movement regions and these coarse movement regions are arranged to be point-symmetric with respect to the center of the bending operation region BE4.

Each of the direction designation directions includes two or more sub-regions. Each of the minute movement region, the coarse movement region, and the common region in each direction designation region includes one or more sub-regions. Each sub-region is associated with a bending control value that is set in accordance with the position of that sub-region. The nonvolatile memory 57 stores an LUT including the bending control values associated with the sub-regions. The bending control values included in the LUT are the same as those included in the LUT in the second embodiment.

The minute movement mode is assigned to a minute movement region in each direction designation region. The coarse movement mode is assigned to a coarse movement region in each direction designation region. The minute movement mode or the coarse movement mode is assigned to the common region in each direction designation region. When a user touches a position in the minute movement region, the control unit 50 acquires a bending control value associated with a sub-region at the position from the LUT. The control unit 50 corrects the bending control value using a correction coefficient that is set for the minute movement mode. When the user touches a position in the coarse movement region, the control unit 50 acquires a bending control value associated with a sub-region at the position from the LUT. The control unit 50 corrects the bending control value using a correction coefficient that is set for the coarse movement mode. The correction coefficient set for the coarse movement mode is different from that set for the minute movement mode.

When the user touches a position in the common region, the control unit 50 sets the bending mode to the minute movement mode or the coarse movement mode in accordance with the previously set bending mode. The control unit 50 acquires a bending control value associated with a sub-region at the position touched by the user from the LUT. The control unit 50 corrects the bending control value using a correction coefficient that is set for the minute movement mode or the coarse movement mode.

Similarly to the first modified example of the second embodiment, in order to make an operational feeling in accordance with the bending direction of the insertion unit 2 uniform, the correction coefficient in the same bending mode varies depending on the bending direction. That is, a correction coefficient for bending the insertion unit 2 in a direction with a small diagonal component is different from that for bending the insertion unit 2 in a direction with a large diagonal component.

In the first modified example of the third embodiment, the bending operation region is divided into many regions, and correction coefficients corresponding to the bending direction of the insertion unit 2 are assigned to the regions. Therefore, it is possible to obtain a uniform operational feeling regardless of the bending direction of the insertion unit 2.

### Second modified example of third embodiment

A second modified example of the third embodiment of the present invention will be described. FIG. 23 shows another example of the bending operation region. The control unit 50 sets a bending operation region BE5 shown in FIG. 23 on the touch panel 52.

The bending operation region BE5 includes a minute movement region BE51, a coarse movement region BE52, a common region BE53, and a dead region BE54. The minute movement region BE51, the coarse movement region BE52, and the common region BE53 correspond to the minute movement region BE31, the coarse movement region BE32, and the common region BE33 shown in FIG. 18.

The dead region BE54 includes the center of the bending operation region BE5. A dead mode is assigned to the dead region BE54. The dead region BE54 includes one or more sub-regions. Each sub-region is associated with a bending control value that is set in accordance with the position of that sub-region.

A user performs a touch operation in the bending operation region BE5 and touches a touch region PD5. When the user performs a slide operation in the bending operation region BE5, the touch region PD5 moves with movement of the user’s finger. The touch operation and the slide operation correspond to the bending operation. The control unit 50 determines the bending mode and the bending control value in accordance with the position of the touch region PD5.

In the example shown in FIG. 12 described above, the sub-regions PR1 above the straight line L1 are associated with the bending control value for bending the insertion unit 2 at least in the U direction. The sub-regions PR1 below the straight line L1 are associated with the bending control value for bending the insertion unit 2 at least in the D direction. When the user moves the touch region PD1 such that the touch region PD1 crosses the straight line L1, the bending direction of the insertion unit 2 changes from the U direction to the D direction or from the D direction to the U direction. Similarly, when the user moves the touch region PD1 such that the touch region PD1 crosses the straight line L2, the bending direction of the insertion unit 2 changes from the R direction to the L direction or from the L direction to the R direction.

In the example shown in FIG. 12, there is a likelihood that the touch region PD1 will cross the straight line L1 or the straight line L2 in a region in the vicinity of the center C1 at which the straight line L1 and the straight line L2 cross each other. Therefore, there is a likelihood that the bending direction of the insertion unit 2 will change rapidly for a short time. On the other hand, in the example shown in FIG. 23, the dead region BE54 is set to avoid a rapid change in the bending direction of the insertion unit 2.

When the position of the touch region PD5 is included in the dead region BE54, the control unit 50 acquires a bending control value associated with a sub-region at the position from the LUT. The control unit 50 corrects the bending control value using a correction coefficient that is set for the dead mode. For example, the correction coefficient is 0, and the control unit 50 calculates the bending control value as a median value by multiplying the bending control value by the correction coefficient. The median value corresponds to the smallest amount of bending. For example, the amount of bending is 0, and the median value is 0. In the LUT, the bending control value associated with the sub-regions in the dead region BE54 may be a median value.

When the position of the touch region PD5 is included in the dead region BE54, the control unit 50 does not bend the insertion unit 2. When the position of the touch region PD5 is included in the bending operation region BE5 other than the dead region BE54, the control unit 50 bends the insertion unit 2. The control unit 50 may set a bending operation region including the dead region BE54 and not including the common region BE53 on the touch panel 52. The bending operation region BE4 shown in FIG. 22 may include the same dead region as the dead region BE54.

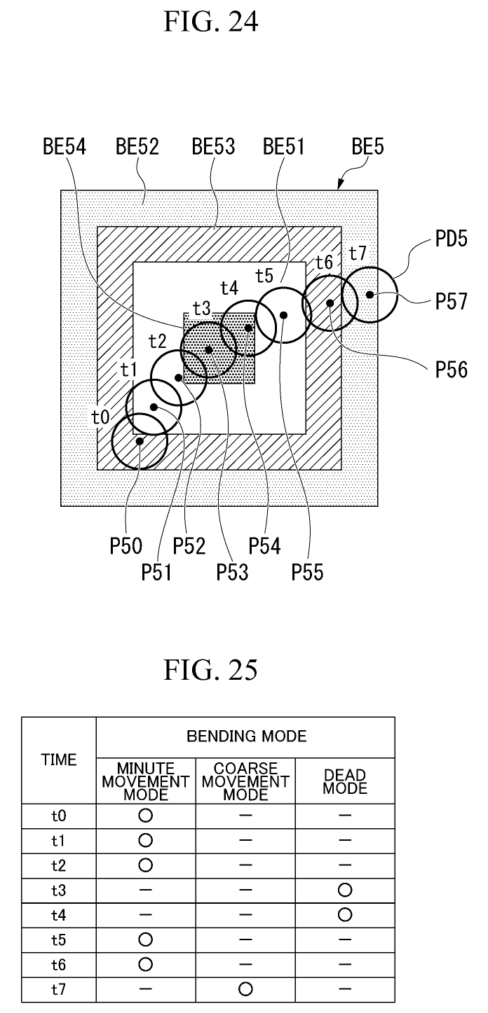

FIG. 24 shows an example of a change in position of the touch region PD5 in the bending operation region BE5. The user touches the bending operation region BE5 at time t0. At this time, the control unit 50 starts receiving position information output from the touch panel 52. The touch region PD5 is located at a position P50. Thereafter, the user moves the finger on the bending operation region BE5 in a state in which the finger has touched the bending operation region BE5. Due to this, the touch region PD5 moves.

The touch region PD5 at times t1, t2, t3, t4, t5, and t6 is located at positions P51, P52, P53, P54, P55, and P56, respectively. The touch region PD5 moves to a position P57 at time t7. The user detaches the finger from the bending operation region BE5 at time t7. At this time, the control unit 50 ends receiving the position information output from the touch panel 52.

FIG. 25 shows an example of a bending mode corresponding to movement of the touch region PD5 shown in FIG. 24. At time t0, the touch region PD5 is located in the common region BE53. The control unit 50 bends the insertion unit 2 in the minute movement mode. At times t1 and t2, the touch region PD5 is located in the minute movement region BE51. Therefore, the control unit 50 bends the insertion unit 2 in the minute movement mode.

At times t3 and t4, the touch region PD5 is located in the dead region BE54. Therefore, the control unit 50 sets the bending mode to the dead mode and does not bend the insertion unit 2. At time t5, the touch region PD5 is located in the minute movement region BE51. Therefore, the control unit 50 bends the insertion unit 2 in the minute movement mode.

At time t6, the touch region PD5 is located in the common region BE53. Since the touch region PD5 moves from the minute movement region B51 to the common region BE53, the control unit 50 bends the insertion unit 2 in the minute movement mode. At time t7, the touch region PD5 is located in the coarse movement region BE52. Therefore, the control unit 50 bends the insertion unit 2 in the coarse movement mode.

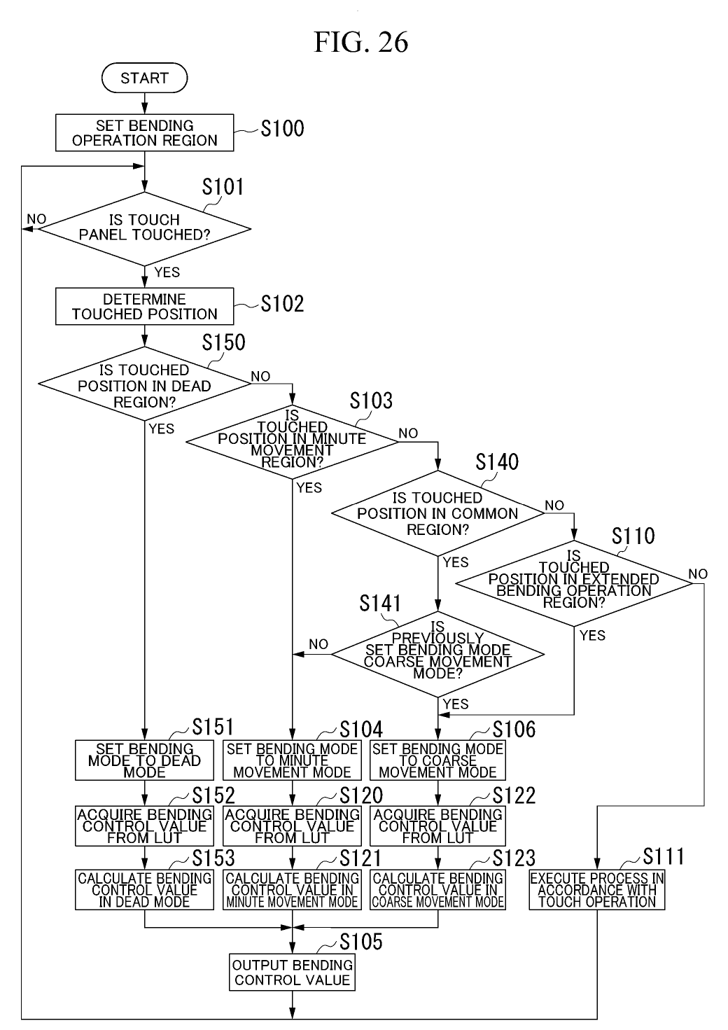

FIG. 26 shows an example of a procedure of a process for determining a bending mode and a bending control value. Operations of the endoscope system 1 will be described by using FIG. 26. The same processes as those shown in FIG. 21 will not be described.

After Step S102, the control unit 50 determines whether the position touched by the user is in the dead region (Step S150).

When the control unit 50 determines that the position touched by the user is in the dead region in Step S150, the control unit 50 sets the bending mode to the dead mode. The volatile memory 56 stores the mode information indicating the dead mode (Step S151).

After Step S151, the control unit 50 identifies a table number corresponding to the position touched by the user. The table number corresponds to a sub-region. The control unit 50 acquires a bending control value associated with that table number from the LUT (Step S152).

After Step S152, the control unit 50 corrects the acquired bending control value using a method corresponding to a bending mode indicated by mode information. For example, the control unit 50 calculates the bending control value in the dead mode by multiplying the bending control value by 0 (Step S153). After Step S153, Step S105 is executed.

When the control unit 50 determines that the position touched by the user is not in the dead region in Step S150, Step S103 is executed.

In the example shown in FIG. 26, the method of determining a bending control value is the same as that in the second embodiment. Any method can be used to determine a bending control value in the second modified example of the third embodiment.

Each aspect of the present invention may include the following modified example. Each of two or more direction designation regions (such as the direction designation region BE1U) includes a third region (a dead region) that is different from both the first region (such as the minute movement region BE1U1) and the second region (such as the coarse movement region BE1U2). When a position indicated by position information output from the touch panel 52 is included in the third region, the control unit 50 does not bend the insertion unit 2.

In the second modified example of the third embodiment, when a user touches a position in the dead region, the control unit 50 does not receive the user’s bending operation. Therefore, the endoscope system 1 can avoid a rapid change in the bending direction of the insertion unit 2.

### Fourth embodiment

A fourth embodiment of the present invention will be described. In the fourth embodiment, the endoscope system 1 shown in FIG. 1 is used. The endoscope system 1a shown in FIG. 10 or the endoscope system 1b shown in FIG. 11 may be used.

In the fourth embodiment, the bending operation region occupies a half or more of the screen of the touch panel 52. In the following example, the bending operation region occupies the whole screen of the touch panel 52.

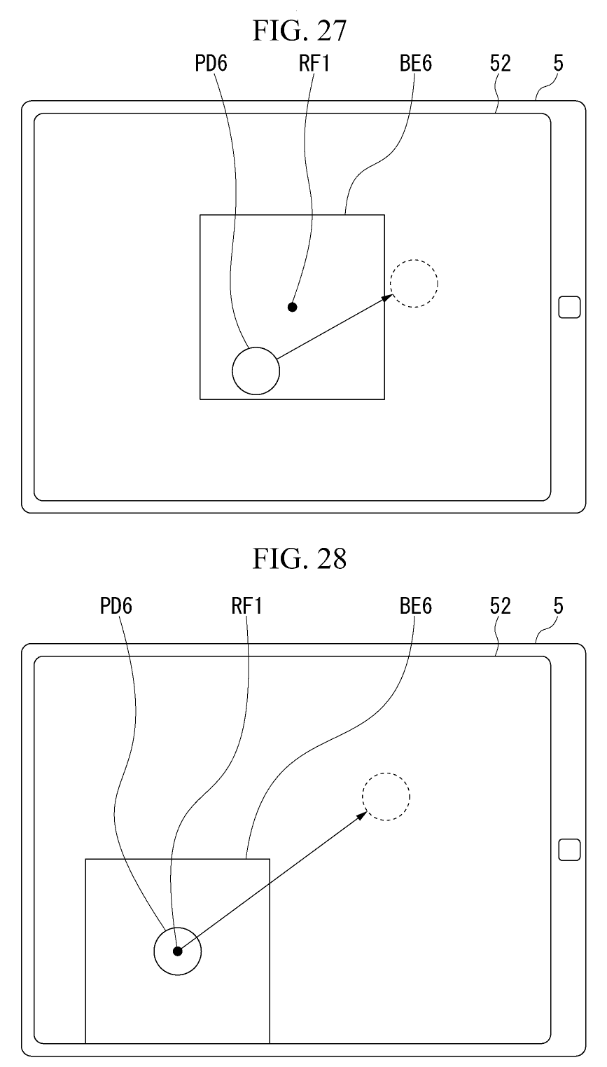

FIG. 27 shows an example of a bending operation region. The control unit 50 sets a bending operation region BE6 shown in FIG. 27 on the touch panel 52. A reference position RF1 of the bending operation region BE6 matches the center of the touch panel 52. A bending control value associated with a sub-region adjacent to the reference position RF1 corresponds to the smallest amount of bending out of amounts of bending that can be set for the insertion unit 2. The amount of bending may be 0. A user moves a touch region PD6 in the bending operation region BE6. The control unit 50 determines a bending mode and a bending control value in accordance with the position of the touch region PD6. The user can perform a bending operation at any position on the screen of the touch panel 52.

Each aspect of the present invention may include the following modified example. The control unit 50 sets the bending operation region to occupy greater than or equal to a half of the screen of the touch panel 52 (a display).

In the fourth embodiment, a user can perform a bending operation using the whole screen of the touch panel 52. When the main unit 5 is a small-sized device such as a smartphone, the endoscope system 1 can secure a bending operation region with a sufficient size.

### First modified example of fourth embodiment

A first modified example of the fourth embodiment of the present invention will be described. In the first modified example of the fourth embodiment, the control unit 50 sets a bending operation region based on a position touched by a user.

FIG. 28 shows an example of a bending operation region. A user causes a finger to approach the touch panel 52 and touches any position on the screen of the touch panel 52. The control unit 50 sets a bending operation region BE6 shown in FIG. 28 on the touch panel 52. A reference position RF1 of the bending operation region BE6 matches the position touched by the user. The user moves a touch region PD6 from the first touched position. The control unit 50 determines a bending mode and a bending control value in accordance with the position of the touch region PD6. The position of the bending operation region BE6 is fixed until the user detaches the finger from the screen of the touch panel 52.

When the user detaches the finger from the screen of the touch panel 52, setting of the bending operation region BE6 is released. When the user touches any position on the screen of the touch panel 52, the control unit 50 sets the bending operation region on the touch panel 52 again based on the position touched by the user.

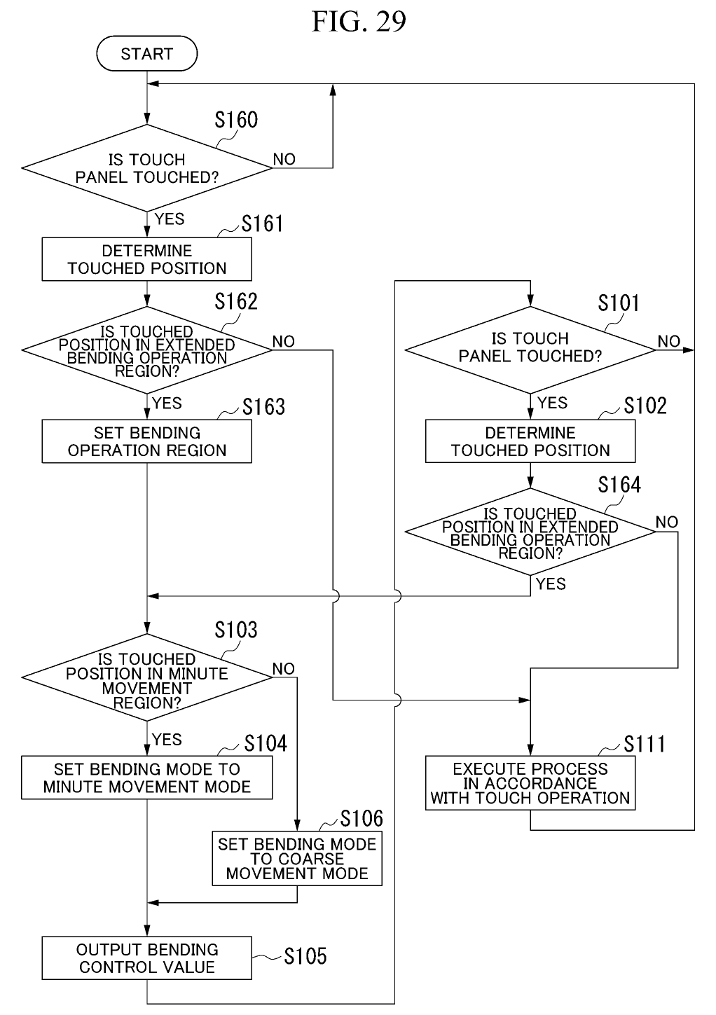

FIG. 29 shows an example of a procedure of a process for determining a bending mode and a bending control value. Operations of the endoscope system 1 will be described by using FIG. 29. The same processes as those shown in FIG. 9 will not be described.

The touch panel 52 includes the extended bending operation region 52a and the invalid region 52b shown in FIG. 8. The control unit 50 sets the bending operation region in the extended bending operation region 52a in Step S163 described later.

The control unit 50 monitors a signal output from the touch panel 52 and determines whether the touch panel 52 is touched (Step S160). When the control unit 50 determines that the touch panel 52 is not touched in Step S160, Step S160 is executed again. The control unit 50 repeats the determination of Step S160 until a user touches the touch panel 52.

When the control unit 50 determines that the touch panel 52 is touched in Step S160, the control unit 50 receives position information output from the touch panel 52 and determines a position on the touch panel 52 touched by the user (Step S161).

After Step S161, the control unit 50 determines that the position touched by the user is in the extended bending operation region 52a (Step S162).

When the control unit 50 determines that the position touched by the user is in the extended bending operation region 52a in Step S162, the control unit 50 sets a bending operation region on the touch panel 52. At this time, the control unit 50 sets a reference position of the bending operation region to the position determined in Step S161 (Step S163).

After Step S163, Steps S103, S104, S105, and S101 are sequentially executed. Alternatively, after Step S163, Steps S103, S106, S105, and S101 are sequentially executed. When the control unit 50 determines that the touch panel 52 is not touched in Step S101, Step S160 is executed. When the control unit 50 determines that the touch panel 52 is touched in Step S101, Step S102 is executed.

After Step S102, the control unit 50 determines whether the position touched by the user is in the extended bending operation region 52a (Step S164).

When the control unit 50 determines that the position touched by the user is in the extended bending operation region 52a in Step S164, Step S103 is executed. When the control unit 50 determines that the position touched by the user is not in the extended bending operation region 52a in Step S162 or S164, Step S111 is executed. After Step S111, Step S160 is executed.

Each aspect of the present invention may include the following modified example. The control unit 50 receives second position information indicating a position on the screen of the touch panel 52 (a display) from the touch panel 52. The control unit 50 sets the bending operation region on the touch panel 52 based on the second position information.

A pointer may be displayed on the display 51. A user may move the pointer on the display 51 using a mouse or the like. When the user performs a click operation or the like using the mouse or the like, the control unit 50 may receive second position information corresponding to the position of the pointer from the mouse or the like. The control unit 50 may set the bending operation region on the display 51 based on the second position information.

In the first modified example of the fourth embodiment, a user can perform a bending operation at any position on the screen (the extended bending operation region 52a) of the touch panel 52 regardless of whether the user operates the touch panel 52 with any of right and left hands.

In this example, setting of the bending operation region is released when the user detaches the finger from the screen of the touch panel 52. The setting of the bending operation region may be maintained until a predetermined time elapses from a timing at which the bending operation region has been set. Alternatively, the setting of the bending operation region may be maintained until the user performs a predetermined operation. When the predetermined time elapses from the timing at which the bending operation region has been set or when the user performs a predetermined operation, the control unit 50 may release the setting of the bending operation region. Even when the user detaches the finger from the screen of the touch panel 52, it is possible to minutely adjust the bending control value.

### Second modified example of fourth embodiment

A second modified example of the fourth embodiment of the present invention will be described. A bending operation region in the second modified example of the fourth embodiment includes a common region similarly to the bending operation region BE3 shown in FIG. 18.

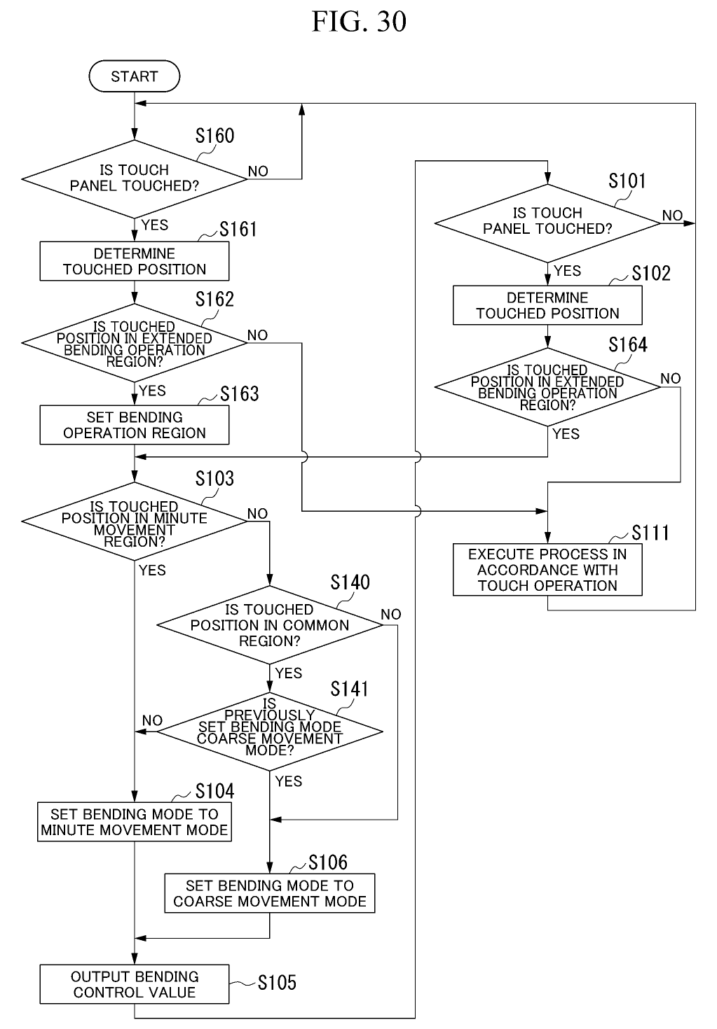

FIG. 30 shows an example of a procedure of a process for determining a bending mode and a bending control value. Operations of the endoscope system 1 will be described by using FIG. 30. The same processes as those shown in FIG. 29 will not be described.

Steps S140 and S141 are added to the processes shown in FIG. 29. Steps S140 and S141 are the same as Steps S140 and S141 shown in FIG. 21.

In the second modified example of the fourth embodiment, the bending operation region includes a common region. Therefore, similarly to the third embodiment, it is possible to improve a user’s operability.

### Third modified example of fourth embodiment

A third modified example of the fourth embodiment of the present invention will be described. A bending operation region in the third modified example of the fourth embodiment includes a common region and a dead region similarly to the bending operation region BE5 shown in FIG. 23.

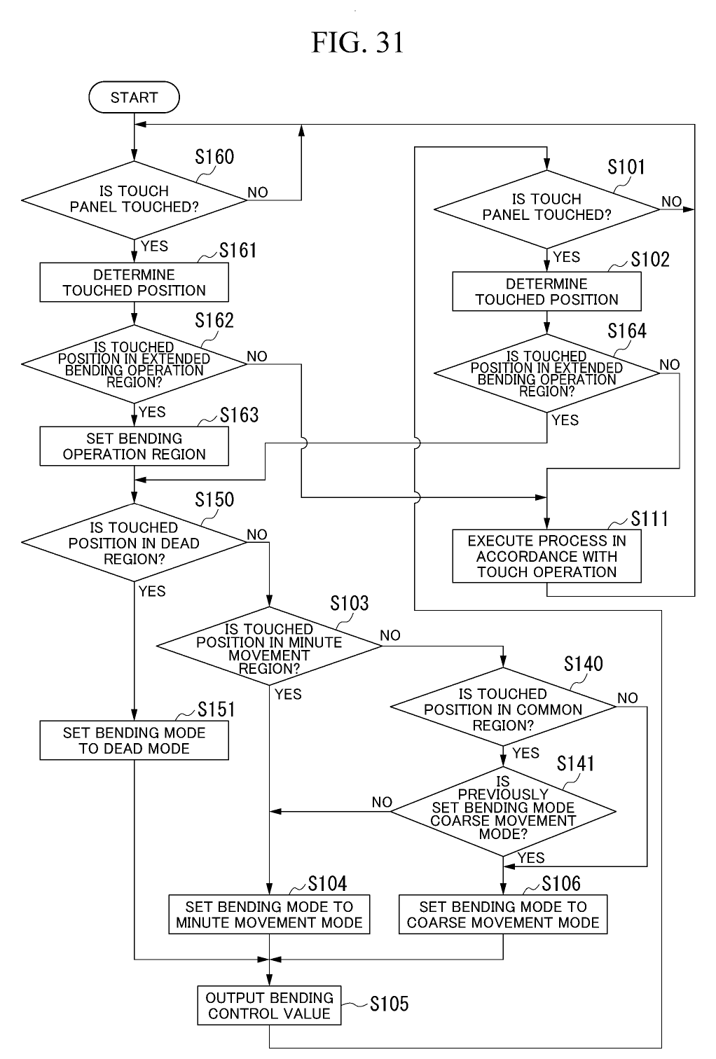

FIG. 31 shows an example of a procedure of a process for determining a bending mode and a bending control value. Operations of the endoscope system 1 will be described by using FIG. 31. The same processes as those shown in FIG. 30 will not be described.

Steps S150 and S151 are added to the processes shown in FIG. 30. Steps S150 and S151 are the same as Steps S150 and S151 shown in FIG. 26.

In the third modified example of the fourth embodiment, the bending operation region includes a dead region. Therefore, similarly to the second modified example of the third embodiment, the endoscope system 1 can avoid a rapid change in the bending direction of the insertion unit 2.

### Fifth embodiment

A fifth embodiment of the present invention will be described. In the fifth embodiment, the endoscope system 1 shown in FIG. 1 is used. The endoscope system 1a shown in FIG. 10 or the endoscope system 1b shown in FIG. 11 may be used.

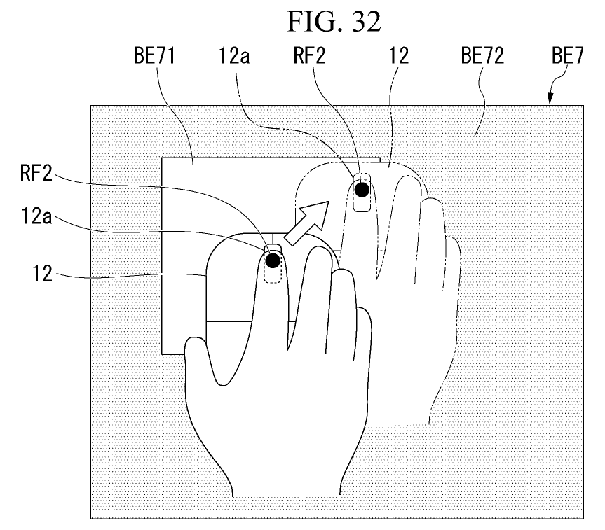

In the fifth embodiment, the external device 11 is a mouse as an input device. A user uses a mouse 12 shown in FIG. 32 as the external device 11. For example, the mouse 12 is an optical mouse. The mouse 12 includes a button 12a. The user performs a bending operation by operating the mouse 12. The endoscope system 1 need not include the touch panel 52.

The user moves the mouse 12 on a table or the like in a state in which the mouse 12 is placed on the table or the like. The mouse 12 generates position information indicating the position of the mouse 12 on the table or the like on which the mouse 12 is placed and transmits the position information to the communication unit 55. The communication unit 55 receives the position information and outputs the position information to the control unit 50. The control unit 50 receives the position information. The control unit 50 calculates a position on the display 51 corresponding to the position indicated by the position information. The control unit 50 displays a pointer at the calculated position. When the user moves the mouse 12, the pointer moves on the display 51.

When the user places the mouse 12 on the table or the like, a reference position RF2 of the mouse 12 and a reference position of a bending operation region are associated. For example, the reference position of the bending operation region is the center of the bending operation region. FIG. 32 conceptually shows a state in which the reference position RF2 of the mouse 12 and the reference position of a bending operation region BE7 are associated. When the user moves the mouse 12, the control unit 50 calculates the amount of movement in the bending operation region BE7 corresponding to the amount of movement of the mouse 12 and calculates a position in the bending operation region BE7 corresponding to the position of the mouse 12. The bending operation region BE7 includes a minute movement region BE71 and a coarse movement region BE72.

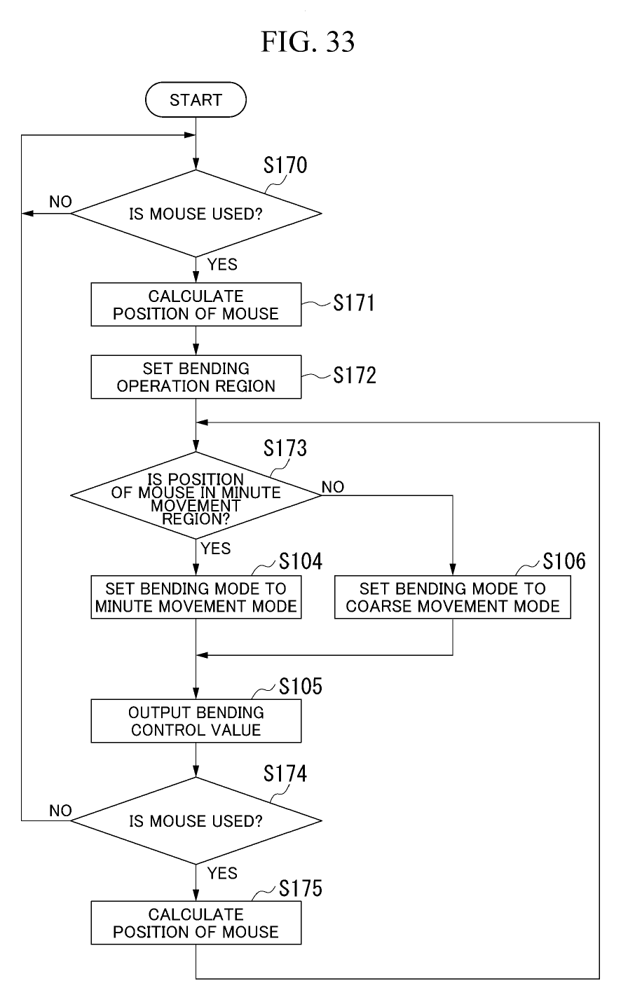

FIG. 33 shows an example of a procedure of a process for determining a bending control value. Operations of the endoscope system 1 will be described by using FIG. 33. The same processes as those shown in FIG. 6 will not be described.

The control unit 50 receives the position information received from the mouse 12 by the communication unit 55 and determines whether the mouse 12 is placed on the table or the like. By doing this, the control unit 50 determines whether the mouse 12 is being used (Step S170). When the mouse 12 is placed on the table or the like, the control unit 50 determines that the mouse 12 is being used. When the user does not place the mouse 12 on the table or the like but holds the mouse 12, the control unit 50 determines that the mouse 12 is not being used.

When the control unit 50 determines that the mouse 12 is not being used in Step S170, Step S170 is executed again. When the control unit 50 determines that the mouse 12 is being used in Step S170, the control unit 50 calculates the position of the mouse 12 based on the position information (Step S171).

After Step S171, the control unit 50 sets a bending operation region by associating the reference position of the mouse 12 with the reference position of the bending operation region (Step S172).

After Step S172, the control unit 50 calculates a position in the bending operation region corresponding to the position of the mouse 12. The control unit 50 determines whether the position is in the minute movement region (Step S173). When the control unit 50 determines that the position of the mouse 12 is in the minute movement region in Step S173, Step S104 is executed. When the control unit 50 determines that the position of the mouse 12 is not in the minute movement region in Step S173, Step S106 is executed.

After Step S105, the control unit 50 receives the position information received from the mouse 12 by the communication unit 55 and determines whether the mouse 12 is being used (Step S174). Step S174 is the same as Step S170.

When the control unit 50 determines that the mouse 12 is not being used in Step S174, Step S170 is executed. When the control unit 50 determines that the mouse 12 is being used in Step S174, the control unit 50 calculates the position of the mouse 12 based on the position information (Step S175). After Step S175, Step S173 is executed.

In the processes shown in FIG. 33, when the user places the mouse 12 on the table or the like, the reference position of the mouse 12 and the reference position of the bending operation region are associated. When a predetermined time elapses after the user has placed the mouse 12 on the table or the like, the reference position of the mouse 12 and the reference position of the bending operation region may be associated. When the user performs a click operation of pressing the button 12a of the mouse 12, the reference position of the mouse 12 and the reference position of the bending operation region may be associated. When the user presses a button of the mouse 12 other than the button 12a, the reference position of the mouse 12 and the reference position of the bending operation region may be associated.

In the processes shown in FIG. 33, when the user lifts up the mouse 12 from the table or the like, the control unit 50 releases setting of the bending operation region. When the user does not move the mouse 12 for a predetermined time, the control unit 50 may release the setting of the bending operation region.

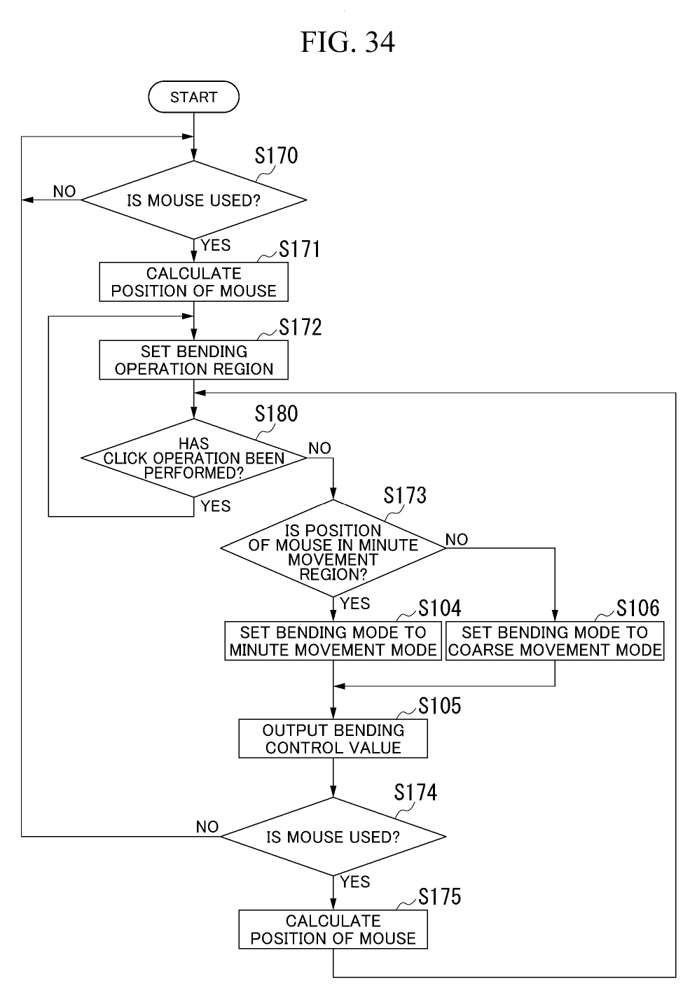

FIG. 34 shows another example of a procedure of a process for determining a bending control value. Operations of the endoscope system 1 will be described by using FIG. 34. The same processes as those shown in FIG. 33 will not be described.

After Step S172, the control unit 50 determines whether a click operation has been performed (Step S180). When the control unit 50 determines that the click operation has been performed in Step S180, Step S172 is executed. When the control unit 50 determines that the click operation has not been performed in Step S180, Step S173 is executed. After Step S175, Step S180 is executed.

In the processes shown in FIG. 34, when the user places the mouse 12 on the table or the like, the reference position of the mouse 12 and the reference position of the bending operation region are associated in Step S172. When the user performs a click operation, the reference position of the mouse 12 and the reference position of the bending operation region are associated in Step S172.

Each aspect of the present invention may include the following modified example. The control unit 50 receives position information indicating the position in the bending operation region corresponding to the position of the mouse 12.

In the fifth embodiment, a user can perform a bending operation using the mouse 12.

### First modified example of fifth embodiment

A first modified example of the fifth embodiment of the present invention will be described. A bending operation region in the first modified example of the fifth embodiment of the present invention includes a common region similarly to the bending operation region BE3 shown in FIG. 18.

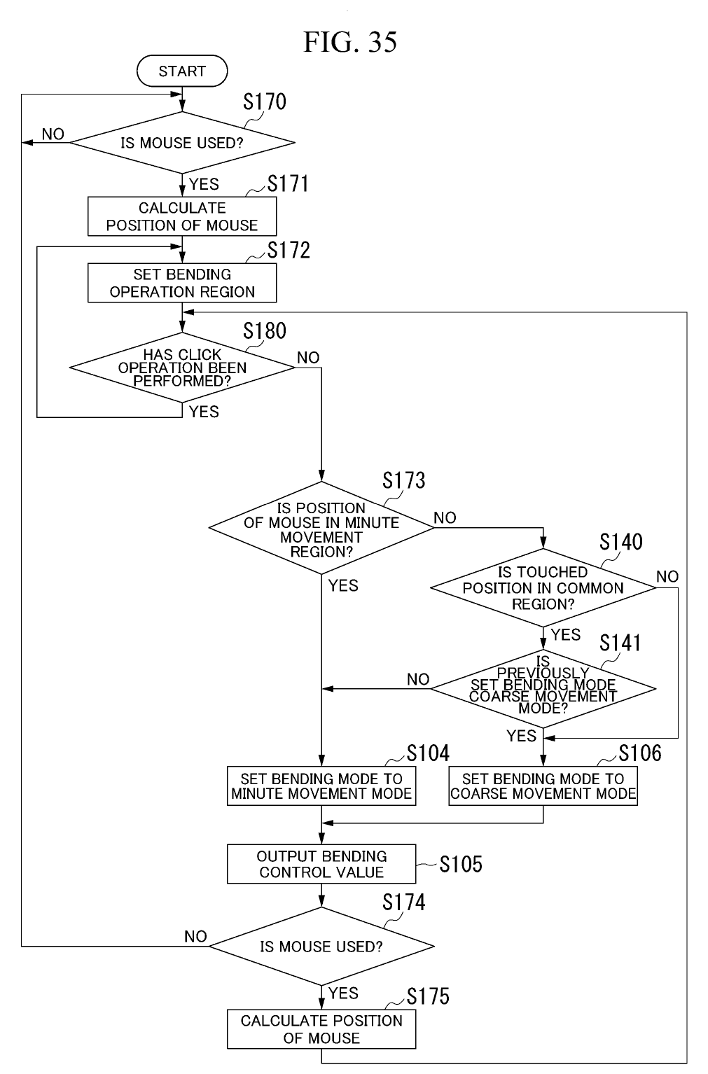

FIG. 35 shows an example of a procedure of a process for determining a bending mode and a bending control value. Operations of the endoscope system 1 will be described by using FIG. 35. The same processes as those shown in FIG. 34 will not be described.

Steps S140 and S141 are added to the processes shown in FIG. 34. Steps S140 and S141 are the same as Steps S140 and S141 shown in FIG. 21.

In the first modified example of the fifth embodiment, the bending operation region includes a common region. Therefore, similarly to the third embodiment, it is possible to improve a user’s operability.

### Second modified example of fifth embodiment

A second modified example of the fifth embodiment of the present invention will be described. A bending operation region in the second modified example of the fifth embodiment of the present invention includes a common region and a dead region similarly to the bending operation region BE5 shown in FIG. 23.

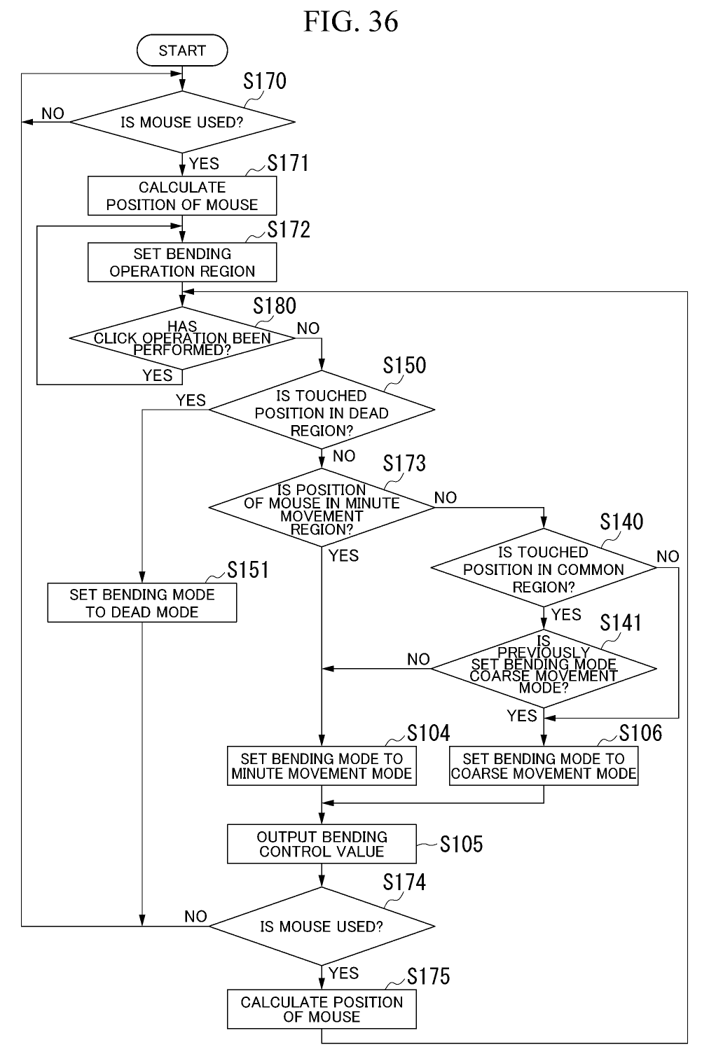

FIG. 36 shows an example of a procedure of a process for determining a bending mode and a bending control value. Operations of the endoscope system 1 will be described by using FIG. 36. The same processes as those shown in FIG. 35 will not be described.

Steps S150 and S151 are added to the processes shown in FIG. 35. Steps S150 and S151 are the same as Steps S150 and S151 shown in FIG. 26.

In the second modified example of the fifth embodiment, the bending operation region includes a dead region. Therefore, similarly to the second modified example of the third embodiment, the endoscope system 1 can avoid a rapid change in the bending direction of the insertion unit 2.

### Sixth embodiment

A sixth embodiment of the present invention will be described. In the sixth embodiment, the endoscope system 1 shown in FIG. 1 is used. The endoscope system 1a shown in FIG. 10 or the endoscope system 1b shown in FIG. 11 may be used.

In the sixth embodiment, a user may touch two or more positions on the screen of the touch panel 52. The control unit 50 executes processes in accordance with the number of positions touched by the user.

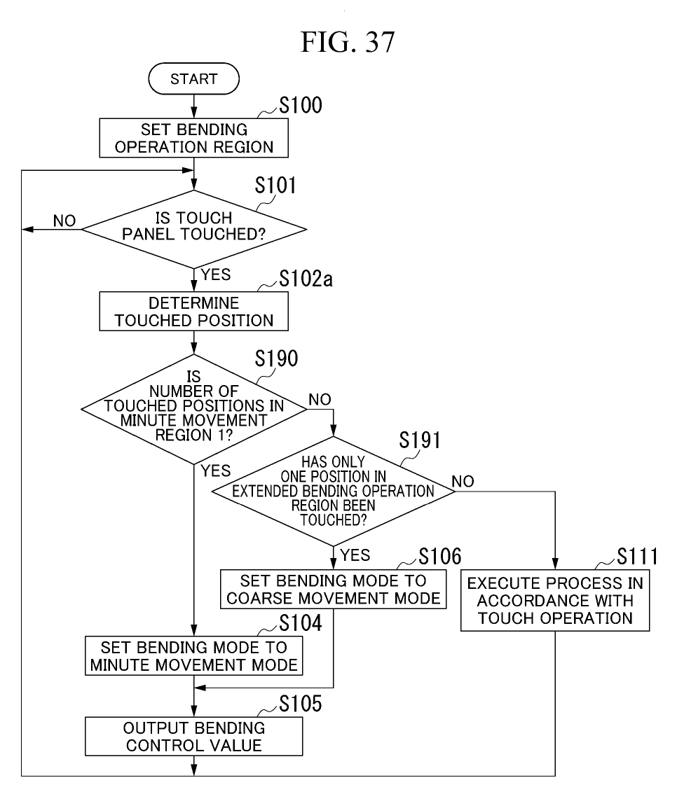

FIG. 37 shows an example of a procedure of a process for determining a bending mode and a bending control value. Operations of the endoscope system 1 will be described by using FIG. 37. The same processes as those shown in FIG. 9 will not be described.

When the control unit 50 determines that the touch panel 52 is touched in Step S101, the control unit 50 receives position information output from the touch panel 52 and determines a position on the touch panel 52 touched by the user. At this time, the control unit 50 may determine two or more positions (Step S102a).

After Step S102a, the control unit 50 determines whether the number of positions touched in the minute movement region is 1. At this time, the control unit 50 determines the number of positions touched in the minute movement region regardless of whether the user has touched a position outside the minute movement region (Step S190). When the control unit 50 determines that the number of positions touched in the minute movement region is 1 in Step S190, Step S104 is executed.

When the control unit 50 determines that the number of positions touched in the minute movement region is not 1 in Step S190, the position touched by the user is not in the minute movement region. At this time, the control unit 50 determines whether only one position outside the minute movement region and inside the extended bending operation region 52a is touched. When the user has not touched a position outside the extended bending operation region 52a and has touched only one position in the extended bending operation region 52a, the control unit 50 determines that only one position in the extended bending operation region 52a is touched. When the user has touched a position outside the extended bending operation region 52a, the control unit 50 determines that a position in the extended bending operation region 52a is not touched (Step S191).

When the control unit 50 determines that only one position in the extended bending operation region 52a is touched in Step S191, Step S106 is executed. When the control unit 50 determines that a position in the extended bending operation region 52a is not touched in Step S191, Step S111 is executed.

In the sixth embodiment, even when two or more positions on the screen of the touch panel 52 have been touched, the endoscope system 1 can reduce a user’s burden for switching between two or more bending modes.

### First modified example of sixth embodiment

A first modified example of the sixth embodiment of the present invention will be described. A bending operation region in the first modified example of the sixth embodiment includes a common region similarly to the bending operation region BE3 shown in FIG. 18.

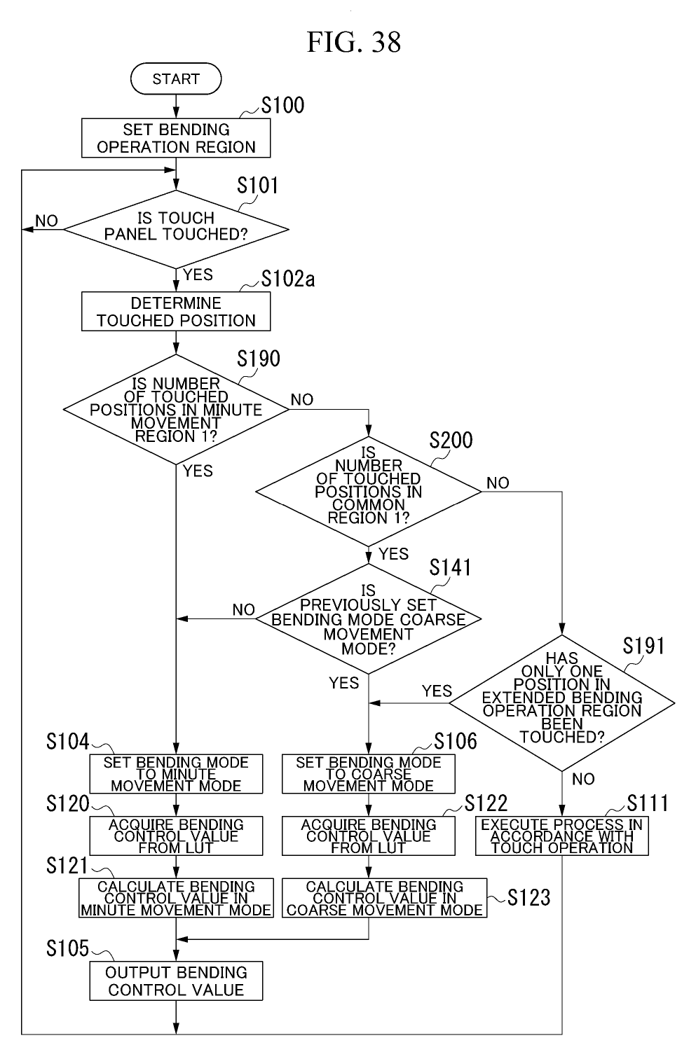

FIG. 38 shows an example of a procedure of a process for determining a bending mode and a bending control value. Operations of the endoscope system 1 will be described by using FIG. 38. The same processes as those shown in FIG. 21 will not be described.

When the control unit 50 determines that the number of positions touched in the minute movement region is not 1 in Step S190, the control unit 50 determines whether the number of positions touched in the common region is 1. At this time, the control unit 50 determines the number of positions touched in the common region regardless of whether the user has touched a position outside the common region (Step S200). When the control unit 50 determines that the number of positions touched in the common region is 1 in Step S200, Step S141 is executed.

When the control unit 50 determines that the number of positions touched in the common region is not 1 in Step S200, the position touched by the user is not in the common region. At this time, Step S191 is executed.

In the first modified example of the sixth embodiment, similarly to the third embodiment, since the bending operation region assigned to the bending mode is widened, it is possible to improve a user’s operability.

### Second modified example of sixth embodiment

A second modified example of the sixth embodiment of the present invention will be described. In the second modified example of the sixth embodiment, the control unit 50 detects that a user’s finger has been detached from the screen of the touch panel 52 and performs a predetermined process. In the following example, the control unit 50 executes a bending lock process as the predetermined process. The control unit 50 maintains a bent state of the distal end portion 2a of the insertion unit 2 in the bending lock process.

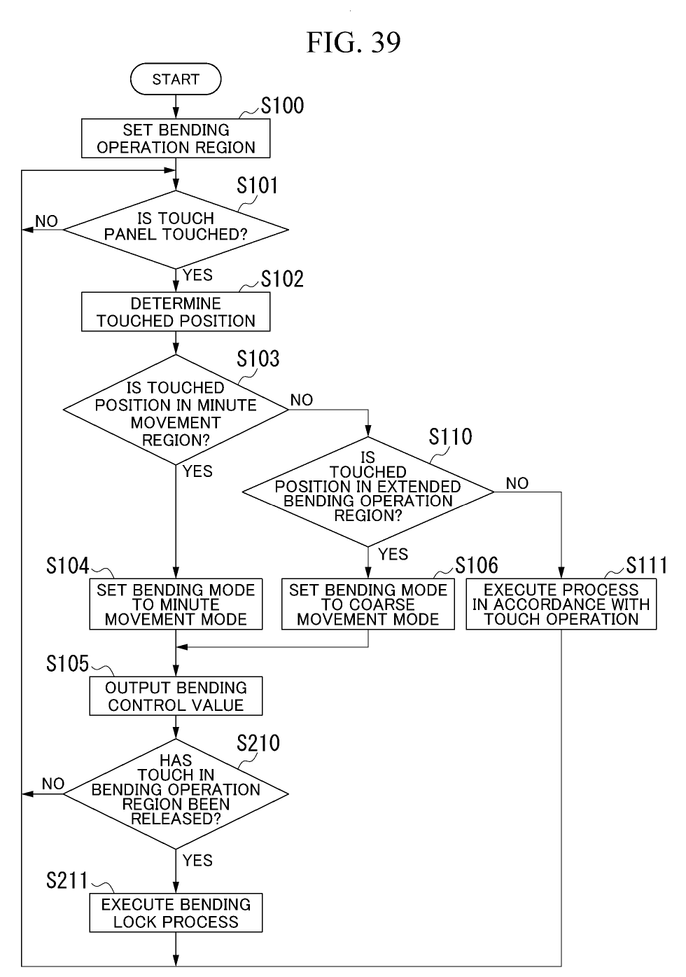

FIG. 39 shows an example of a procedure of a process for determining a bending mode and a bending control value. Operations of the endoscope system 1 will be described by using FIG. 39. The same processes as those shown in FIG. 9 will not be described.

After Step S105, the control unit 50 determines whether the user’s finger has been detached from the bending operation region in the screen of the touch panel 52. That is, the control unit 50 determines whether a touch in the bending operation region has been released. When the user’s finger has been detached from the bending operation region, the control unit 50 determines that a touch in the bending operation region has been released. When the user is touching the bending operation region, the control unit 50 determines that a touch in the bending operation region has not been released (Step S210).

When the control unit 50 determines that a touch in the bending operation region has not been released in Step S210, Step S101 is executed. When the control unit 50 determines that a touch in the bending operation region has been released in Step S210, the control unit 50 executes the bending lock process (Step S211). The distal end portion 2a of the insertion unit 2 does not return to an initial position, and the insertion unit 2 maintains the bent state. After Step S211, Step S101 is executed.

In the above-described example, when the bending operation region is touched and then the touch in the bending operation region has been released, the control unit 50 executes the bending lock process. When the bending operation region is touched, the user’s finger has moved to the outside of the bending operation region, and the touch has been released outside the bending operation region, the control unit 50 does not perform the bending lock process.

When the bending operation region is touched, the user’s finger has moved to the outside of the bending operation region, and the touch has been released outside the bending operation region, the control unit 50 may perform the bending lock process. When the bending operation region is touched and then the touch has been released inside the bending operation region, the control unit 50 need not perform the bending lock process.

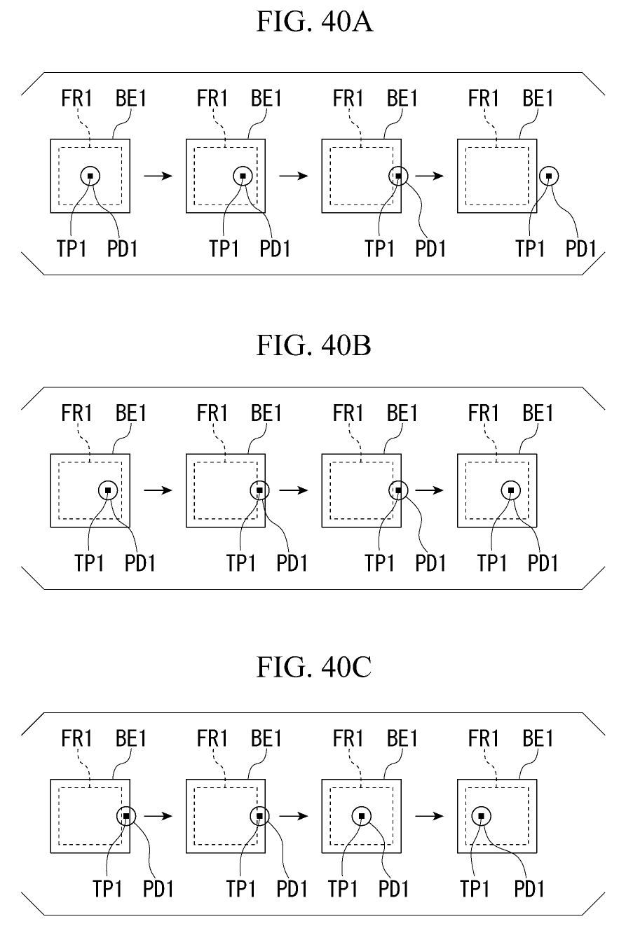

When the user performs a predetermined operation in a state in which the bent state of the distal end portion 2a is maintained, the control unit 50 returns the distal end portion 2a of the insertion unit 2 to the initial position. FIGS. 40A, 40B, and 40C show examples of a change in position of the touch region PD1 in the bending operation region BE1.

The control unit 50 determines that the user has touched a touch position TP1 in the touch region PD1. The control unit 50 sets a region frame FR1 in the bending operation region BE1. The region frame FR1 is not displayed on the display 51. The control unit 50 returns the distal end portion 2a to the initial position in accordance with a positional relationship between the touch position TP1 and the region frame FR1.

In the example shown in FIG. 40A, the user detaches the finger from the bending operation region and then touches a position in the vicinity of the center of the bending operation region BE1. Thereafter, the user moves the finger rightward in a state in which the bending operation region BE1 is touched with the finger. The touch position TP1 moves to the outside of the region frame FR1 and additionally moves to the outside of the bending operation region BE1.

When the touch position TP1 moves to the outside of the region frame FR1, the control unit 50 returns the distal end portion 2a to the initial position. When the user continues to touch a region between the region frame FR1 and the boundary of the bending operation region BE1 for a predetermined time or longer, the control unit 50 may return the distal end portion 2a to the initial position.

In the example shown in FIG. 40B, the user detaches the finger from the bending operation region and then touches a position in the bending operation region BE1. Thereafter, the user moves the finger rightward in a state in which the bending operation region BE1 is touched with the finger. The touch position TP1 moves to the outside of the region frame FR1. Thereafter, the user moves the finger leftward in a state in which the bending operation region BE1 is touched with the finger. The touch position TP1 returns to the inside of the region frame FR1.

When the touch position TP1 moves to the outside of the region frame FR1 as in the example shown in FIG. 40A, the control unit 50 returns the distal end portion 2a to the initial position. When the user does not return the finger to the inside of the region frame FR1 and continues to touch a region between the region frame FR1 and the boundary of the bending operation region BE1 for a predetermined time or longer, the control unit 50 may return the distal end portion 2a to the initial position.

In the example shown in FIG. 40C, the user detaches the finger from the bending operation region and then touches a position in a region between the region frame FR1 and the boundary of the bending operation region BE1. At this time, the touch position TP1 is located in the region between the region frame FR1 and the boundary of the bending operation region BE1. Thereafter, the user moves the finger leftward in a state in which the bending operation region BE1 is touched with the finger. The touch position TP1 moves to the vicinity of the center of the bending operation region BE1.

When the user touches a position outside the region frame FR1, the control unit 50 returns the distal end portion 2a to the initial position. When the user continues to touch the region between the region frame FR1 and the boundary of the bending operation region BE1 for a predetermined time or longer, the control unit 50 may return the distal end portion 2a to the initial position.

In the second modified example of the sixth embodiment, when the user detaches the finger from the bending operation region, the endoscope system 1 can maintain the bent state of the insertion unit 2.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An endoscope system comprising:
an insertion unit configured to be bendable and to acquire an optical image in an observation target; and
a processor configured to:
receive, from a device, position information indicating a position in a bending operation region including two or more direction designation regions corresponding to two or more bending directions of the insertion unit, each of the two or more direction designation regions including a first region and a second region that are different from each other;
bend the insertion unit in a first bending mode in a bending direction corresponding to a direction designation region including the first region when the position indicated by the position information is included in the first region; and
bend the insertion unit in a second bending mode different from the first bending mode in a bending direction corresponding to a direction designation region including the second region when the position indicated by the position information is included in the second region.

2. The endoscope system according to claim 1,
wherein each of the two or more direction designation regions includes a third region that is different from both the first region and the second region, and
wherein the processor is configured not to bend the insertion unit when the position indicated by the position information is included in the third region.

3. The endoscope system according to claim 1,
wherein each of the two or more direction designation regions includes a third region that is different from both the first region and the second region, and
wherein the processor is configured to bend the insertion unit in the first bending mode or the second bending mode in accordance with the position indicated by the position information that has been previously received when the position indicated by the position information is included in the third region.

4. The endoscope system according to claim 3,
wherein the third region is located between the first region and the second region,
wherein the processor is configured to bend the insertion unit in the first bending mode when the position indicated by the position information that has been previously received is included in the first region, and
wherein the processor is configured to bend the insertion unit in the second bending mode when the position indicated by the position information that has been previously received is included in the second region.

5. The endoscope system according to claim 1,
wherein each of the first region and the second region includes two or more sub-regions, and
wherein the processor is configured to bend the insertion unit based on a control value in a sub-region corresponding to the position indicated by the position information out of the two or more sub-regions.

6. The endoscope system according to claim 5, wherein the processor is configured to acquire, from a storage medium, the control value associated with the sub-region corresponding to the position indicated by the position information.

7. The endoscope system according to claim 5, wherein the processor is configured to acquire the control value based on a distance between the position indicated by the position information and a reference position preset in the bending operation region.

8. The endoscope system according to claim 1, wherein the processor is configured to:
start receiving the position information at a first timing;
end receiving the position information at a second timing different from the first timing; and
continuously receive the position information between the first timing and the second timing.

9. The endoscope system according to claim 1, wherein the processor is configured to display the first region and the second region on a display.

10. The endoscope system according to claim 1, wherein the processor is configured to set the bending operation region such that the first region and the second region are disposed to be point-symmetric with respect to a reference position.

11. The endoscope system according to claim 1, wherein the processor is configured to set the bending operation region to occupy greater than or equal to a half of a screen of a display.

12. The endoscope system according to claim 1, wherein the processor is configured to:
receive, from the device, second position information indicating a position on a screen of a display; and
set the bending operation region on the display based on the second position information.

13. The endoscope system according to claim 1, further comprising an endoscope device including the insertion unit, the device, and the processor.

14. The endoscope system according to claim 1, further comprising:
an endoscope device including the insertion unit; and
an operation device separated from the endoscope device and configured to communicate with the endoscope device,
wherein the operation device includes the device and the processor.

15. The endoscope system according to claim 1,
wherein the device is a touch panel, and
wherein the processor is configured to receive the position information indicating a position at which an object has touched the touch panel.

16. The endoscope system according to claim 1,
wherein the device is a mouse, and
wherein the processor is configured to receive the position information indicating the position of the bending operation region corresponding to a position of the mouse.

17. A bending control method of controlling a bending operation of an insertion unit configured to be bendable and to acquire an optical image in an observation target, the bending control method comprising:
receiving, from a device, position information indicating a position in a bending operation region including two or more direction designation regions corresponding to two or more bending directions of the insertion unit, each of the two or more direction designation regions including a first region and a second region that are different from each other;
bending the insertion unit in a first bending mode in a bending direction corresponding to a direction designation region including the first region when the position indicated by the position information is included in the first region; and
bending the insertion unit in a second bending mode different from the first bending mode in a bending direction corresponding to a direction designation region including the second region when the position indicated by the position information is included in the second region.

18. A non-transitory computer-readable recording medium storing a program causing a computer to execute a process of controlling a bending operation of an insertion unit configured to be bendable and to acquire an optical image in an observation target, the program causing the computer to execute:
receiving, from a device, position information indicating a position in a bending operation region including two or more direction designation regions corresponding to two or more bending directions of the insertion unit, each of the two or more direction designation regions including a first region and a second region that are different from each other;
bending the insertion unit in a first bending mode in a bending direction corresponding to a direction designation region including the first region when the position indicated by the position information is included in the first region; and
bending the insertion unit in a second bending mode different from the first bending mode in a bending direction corresponding to a direction designation region including the second region when the position indicated by the position information is included in the second region.
